(19) United States
(12) Patent Application Publication
(10) Pub. No.: US 2010/0060682 A1
(43) Pub. Date: Mar. 11, 2010

(54) LIQUID EJECTING APPARATUS AND METHOD OF FORMING NOZZLE TEST PATTERN

(75) Inventor: Yasushi Akatsuka, Asahi-mura (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/554,829

(22) Filed: Sep. 4, 2009

(30) Foreign Application Priority Data
Sep. 8, 2008 (JP) 2008-229958

(51) Int. Cl. B41J 29/38

(52) U.S. Cl. 347/9

(57) ABSTRACT

A liquid ejecting apparatus includes a head that includes a plurality of nozzles disposed for each color of liquids and ejects liquids from the plurality of nozzles onto a medium and a control unit that forms a nozzle test pattern for testing defective liquid-ejection of a test target nozzle with one from the plurality of nozzles set as the test target nozzle. The control unit performs either a first process in which the nozzle test pattern is formed by having liquids ejected from the test target nozzle and a different nozzle, which is different from the test target nozzle, from the plurality of nozzles land on the medium in an overlapping manner or a second process in which the nozzle test pattern is formed by having only the liquid ejected from the test target nozzle land on the medium in accordance with the type of the medium.

### BACKGROUND

1. Technical Field

The present invention relates to a liquid ejecting apparatus and a method of forming a nozzle test pattern.

2. Related Art

Liquid ejecting apparatuses have been known that have a head including a plurality of nozzles disposed for each color of liquid and ejects liquids from the nozzles onto a medium, and a control unit that forms a nozzle test pattern used for testing the defective liquid-ejection of a test target nozzle with one from the plurality of nozzles set as the test target nozzle. A user using such liquid ejecting apparatuses test whether the test target nozzle is in the defective liquid-ejection state due to nozzle clogging or the like by visually recognizing the nozzle test pattern (for example, see JP-A-2007-168173).

Generally, the nozzle test pattern is formed with a liquid that is ejected from the test target nozzle. In other words, generally, the nozzle test pattern used for testing the defective liquid-ejection of the test target nozzle is printed in a monochrome color with a liquid that is ejected from the test target nozzle.

On the other hand, as the type of the medium on which the nozzle test pattern is formed, a plurality of types of media is used depending on the user's situation and the like. There are cases where there are changes in the visibility (easiness in visual recognition) of the nozzle test pattern that is formed on the medium depending on the type of the medium. In other words, the visibility of the nozzle test pattern depends on the relationship between the color of the liquid forming the nozzle test pattern and the type of the medium. Accordingly, when the nozzle test pattern is formed on the medium with a nozzle that ejects liquid of a color that cannot be easily identified in relation to the ground color of the medium set as the test target nozzle, the nozzle test pattern cannot be easily recognized visually. In such a case, there is a problem that the defective liquid-ejection of the test target nozzle cannot be tested appropriately.

### SUMMARY

An advantage of some aspects of the invention is that it provides a liquid ejecting apparatus and a method of forming a nozzle test pattern which are capable of appropriately forming a nozzle test pattern for testing the defective liquid-ejection of the test target nozzle in accordance with the type of the medium.

According to a major aspect of the invention, there is provided a liquid ejecting apparatus including: a head that includes a plurality of nozzles disposed for each color of liquids and ejects liquids from the plurality of nozzles onto a medium; and a control unit that forms a nozzle test pattern for testing defective liquid-ejection of a test target nozzle with one from the plurality of nozzles set as the test target nozzle. The control unit performs either a first process in which the nozzle test pattern is formed by having liquids ejected from the test target nozzle and a different nozzle, which is different from the test target nozzle, from the plurality of nozzles, land on the medium in an overlapping manner, or a second process in which the nozzle test pattern is formed by having only the liquid ejected from the test target nozzle land on the medium in accordance with the type of the medium.

Other aspects of the invention will be apparent with reference to descriptions below and the accompanying drawings.

At least the following will become apparent with reference to descriptions below and the accompanying drawings.

According to a first aspect of the invention, there is provided a liquid ejecting apparatus including: a head that includes a plurality of nozzles disposed for each color of liquids and ejects liquids from the plurality of nozzles onto a medium; and a control unit that forms a nozzle test pattern for testing defective liquid-ejection of a test target nozzle with one from the plurality of nozzles set as the test target nozzle. The control unit performs either a first process in which the nozzle test pattern is formed by having liquids ejected from the test target nozzle and a different nozzle, which is different from the test target nozzle, from the plurality of nozzles, land on the medium in an overlapping manner, or a second process in which the nozzle test pattern is formed by having only the liquid ejected from the test target nozzle land on the medium in accordance with the type of the medium. According to the above-described liquid ejecting apparatus, the nozzle test pattern of the test target nozzle can be formed appropriately in accordance with the type of the medium.

In addition, in the above-described liquid ejecting apparatus, the control unit may be configured to form the nozzle test patterns with each of the plurality of nozzles set as the test target nozzle and determine whether to perform the first process out of the first process and the second process for forming the nozzle test pattern of the nozzle test patterns in accordance with the type of the medium. In such a case, when the nozzle test pattern is formed with each of the plurality of nozzles set as the test target nozzle, the nozzle test pattern can be appropriately formed in accordance with the type of the medium.

In addition, in the above-described liquid ejecting apparatus, the control unit may be configured to perform either a third process in which the nozzle test pattern, which has a color that is different from the color of the liquid ejected from the test target nozzle, is formed by having the liquids ejected from the test target nozzle and the different nozzle land on the medium in an overlapping manner so as to be mixed together, or a fourth process in which the nozzle test pattern, that is surround by a base and is formed with the liquid ejected from the test target nozzle, is formed by forming the base that is formed with the liquid ejected from the different nozzle by having the liquid ejected from the different nozzle land on the medium and then having the liquid ejected from the test target nozzle land on the base, as the first process, and the control unit may be configured to determine whether to perform either the third process or the fourth process for forming the nozzle test pattern of the nozzle test patterns, which is formed by the first process, in accordance with the type of the medium and the color of the liquid ejected from the test target nozzle. In such a case, the nozzle test patterns that are formed on the medium by the first process can be formed so as to be easily recognized visually by a user in accordance with the color of the medium and the color of the liquid ejected from the test target nozzle.

In addition, in the above-described liquid ejecting apparatus, when both the color of the medium as the type of the medium and the color of the liquid ejected from the test target nozzle are a chromatic color of the same color, the control unit may be configured to form the nozzle test pattern for testing defective liquid-ejection of the test target nozzle by the third process. In such a case, when both the color of the medium and the color of the liquid ejected from the test target nozzle are a chromatic color of the same color, the nozzle test pattern of the test target nozzle can be formed so as to be easily recognized by the user visually.

In addition, in the above-described liquid ejecting apparatus, when both the color of the medium as the type of the medium and the color of the liquid ejected from the test target nozzle are white, the control unit may be configured to form the nozzle test pattern for testing defective liquid-ejection of the test target nozzle by the fourth process. In such a case, when both the color of the medium and the color of the liquid ejected from the test target nozzle are white, the nozzle test pattern of the test target nozzle can be formed so as to be easily recognized by the user visually.

In addition, in the above-described liquid ejecting apparatus, when the medium is a transparent medium and the color of the liquid ejected from the test target nozzle is a chromatic color, the control unit may be configure to form the nozzle test pattern for testing defective liquid-ejection of the test target nozzle by the fourth process. In such a case, when the medium is a transparent medium and the color of the liquid ejected from the test target nozzle is a chromatic color, the nozzle test pattern of the test target nozzle can be formed so as to be easily recognized by the user visually.

In addition, the above-described liquid ejecting apparatus may further include a color measuring device for measuring the color of the medium, and the type of the medium is defined as the color that is measured by the color measuring device. In such a case, the color of the medium can be determined accurately. Accordingly, the nozzle test pattern of the test target nozzle can be more appropriately formed in accordance with the color of the medium.

According to a second aspect of the invention, there is provided a method of forming a nozzle test pattern in which the nozzle test pattern for testing defective liquid-ejection of a test target nozzle is formed on a medium with one from a plurality of nozzles disposed for each color of liquids set as the test target nozzle. The method includes: determining the type of the medium; and performing either a first process in which the nozzle test pattern is formed by having liquids ejected from the test target nozzle and a different nozzle, which is different from the test target nozzle, of the plurality of nozzles land on the medium in an overlapping manner, or a second process in which the nozzle test pattern is formed by having only the liquid ejected from the test target nozzle land on the medium in accordance with the determined color of the medium. According to the above-described method, the nozzle test pattern of the test target nozzle can be appropriately formed in accordance with the type of the medium.

### BRIEF DESCRIPTION OF THE DRAWINGS

The invention will be described with reference to the accompanying drawings, wherein like numbers reference like elements.

FIG. 1 is a block diagram showing the entire configuration of a printer.

FIG. 2A schematically shows the internal configuration of the printer, and FIG. 2B shows a cross-sectional view of the internal configuration of the printer 10.

FIG. 3 is a diagram showing the arrangement of nozzles.

FIG. 4 is a flowchart of a printing process.

FIG. 5 is an explanatory diagram of a print data generating process.

FIG. 6 is a diagram showing a setting screen of a printer driver.

FIG. 7 is a diagram showing a utility screen.

FIG. 8A is a diagram showing a nozzle test pattern NP(K).

FIG. 8B is an enlarged diagram of one block BP(K).

FIGS. 9A and 9B are explanatory diagrams of a method of testing a nozzle by using a nozzle test pattern NP.

FIG. 10 is a diagram showing a cleaning setting screen.

FIG. 11 is a diagram showing a mixed nozzle test pattern NP(CY).

FIG. 12 is a diagram showing a nozzle test pattern NP(W) that is formed on a background image BG.

FIG. 13 is a diagram showing an example of the flow of a nozzle test pattern forming process according to an embodiment of the invention.

FIG. 14 is a diagram showing the flow until print data of the nozzle test pattern NP is transmitted after a user's request is accepted by a printer driver.

FIG. 15 is a diagram showing a designation screen 124.

FIG. 16 is a diagram showing the correspondence relationship between the type of the print data of the nozzle test pattern NP, the color of ink ejected from a test target nozzle, and the color of a test sheet TS.

FIG. 17 is a diagram showing each nozzle test pattern NP that is formed on a yellow test sheet TS.

FIG. 18 is a diagram showing each nozzle test pattern NP that is formed on a white test sheet TS.

FIG. 19 is a block diagram showing the entire configuration of a printer according to a second embodiment of the invention.

FIG. 20A is a diagram showing a base pattern UG as a modified example of a base.

FIG. 20B is a diagram showing a nozzle test pattern NP(W) of a white ink nozzle that is formed on the base pattern UG.

### DESCRIPTION OF EXEMPLARY EMBODIMENTS

Configuration of Liquid Ejecting Apparatus according to Embodiment of Invention

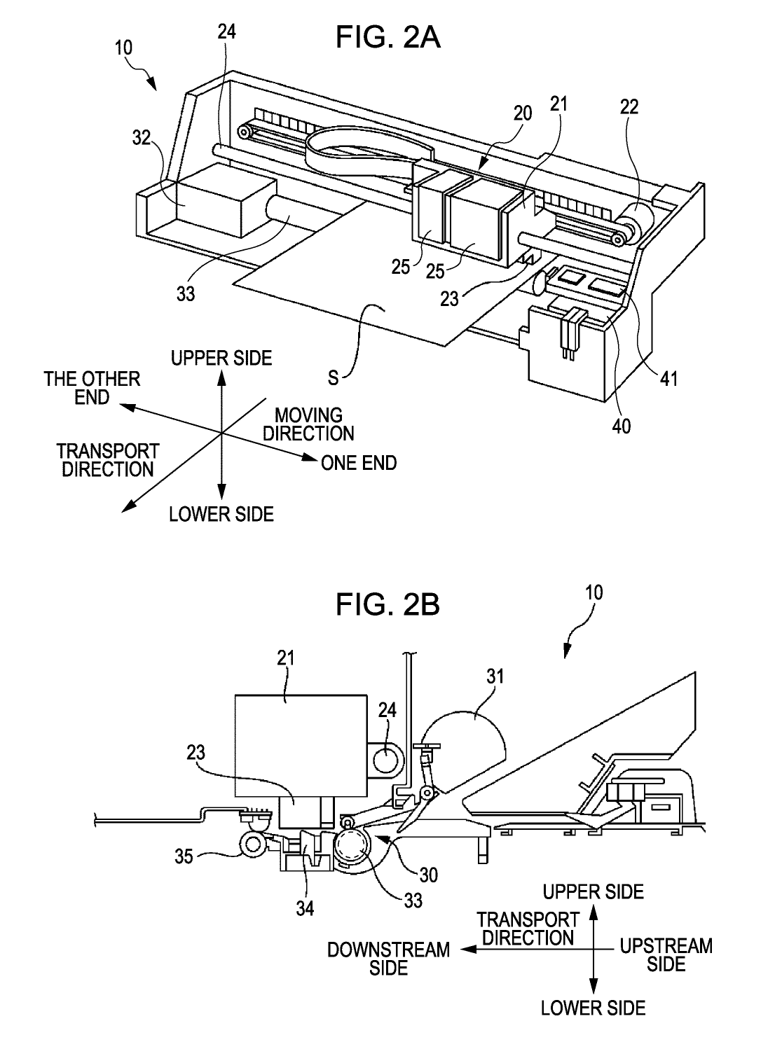

In this embodiment, as an example of a liquid ejecting apparatus, an ink jet printer (hereinafter, referred to as a printer 10) will be described. The printer 10 is an apparatus that forms (prints) an image on a medium S by ejecting ink as an example of a liquid on the medium S (see FIGS. 2A and 2B) such as a paper sheet, a cloth, or a film sheet. As the ink, either water-based ink or oil-based ink may be used.

According to the printer 10 of this embodiment, ink of four CMYK colors and white ink are ejected. This white ink is ink that is used for printing a background image, for example, on a film sheet by monochrome coating on the entire surface for a case where a transparent film sheet is used as the medium S. In other words, by coating ink of CMYK colors on a background image that is formed with white ink, an image (main image) can be printed on the background image. When white ink according to this embodiment is overlapped with ink of a different color, the white ink is not mixed with the ink of the different color (the white ink and the ink of the different color do not spread into each other).

### <<Basic Configuration of Printer 10>>

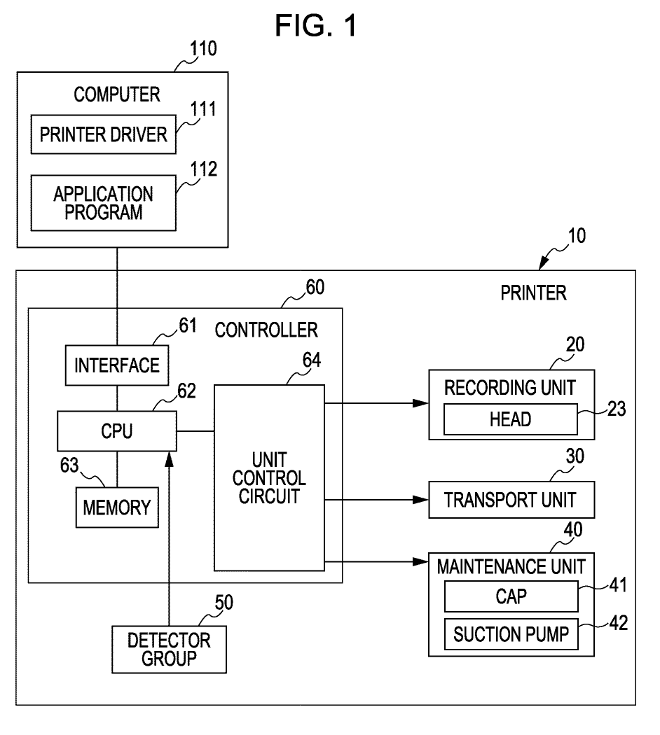

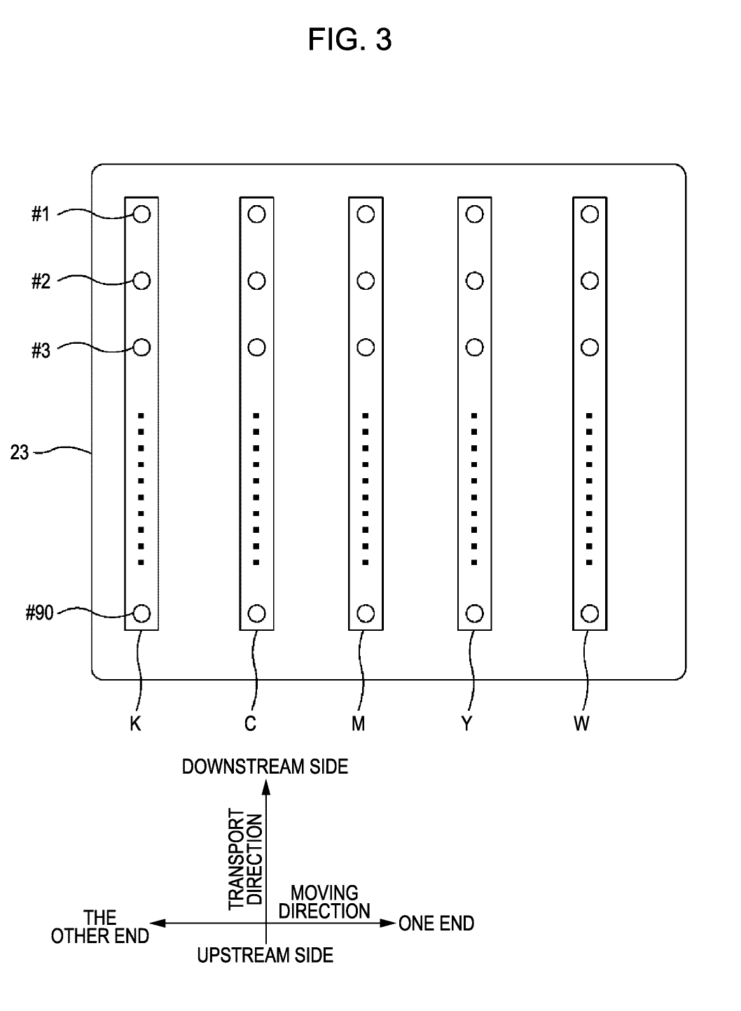

The basic configuration of the printer 10 will be described with reference to FIGS. 1 to 3. FIG. 1 is a block diagram showing the entire configuration of the printer 10. FIG. 2A schematically shows the internal configuration of the printer 10, and FIG. 2B shows a cross-sectional view of the internal configuration of the printer 10. FIG. 3 is a diagram showing the arrangement of nozzles.

The printer 10, as shown in FIG. 1, includes a recording unit 20, a transport unit 30, a maintenance unit 40, a detector group 50, a controller 60 as an example of a control unit, and the like.

The recording unit 20 records an image on the medium S. As shown in FIGS. 2A and 2B, the recording unit 20 includes a carriage 21, a carriage moving mechanism 22, and a head 23. The carriage 21 is reciprocated along a guide shaft 24 by the carriage moving mechanism 22 in a state being supported by the guide shaft 24 that intersects the transport direction to be described later.

The head 23 includes a bottom face (hereinafter, referred to as a nozzle face) in which nozzles are arranged. The head ejects ink, which is supplied from an ink cartridge 25, onto the medium S from the nozzles in a state in which the nozzle face faces the medium S. In addition, the head 23 is mounted on the carriage 21. Accordingly, the head 23 moves in the same direction as the moving direction of the carriage 21 in accompaniment with the movement of the carriage 21. Then, the head 23 moves in the moving direction so as to bring the nozzle face to face the medium S.

In the nozzle face, as shown in FIG. 3, a plurality of nozzles (in this embodiment, nozzles of five colors) that is arranged for each color of ink is included. Each of the plurality of nozzles is formed by a plurality of (in this embodiment, 90) nozzle holes. The plurality of nozzle holes forms a row so as to be parallel to one another with a constant nozzle pitch in the transport direction to be described later. In addition, numbers are assigned to a nozzle hole so that the numbers are smaller as the nozzle hole is located further toward the downstream side (#1 to #90). For example, the nozzle hole #1 is located on the downstream side in the transport direction relative to the nozzle hole #90. In addition, nozzle holes, to which a same number is assigned, out of the nozzle holes of the ink colors are located in an approximately same position in the transport direction.

In addition, in each nozzle hole, an ink chamber and a piezo element that are not shown in the figure are disposed. As the ink chamber is expanded or contracted by the driving of the piezo element, droplet-shaped ink is ejected from each nozzle hole. As the ejected droplet-shaped ink lands on the medium S, a dot is formed.

The transport unit 30 is for transporting the medium S in the transport direction shown in FIGS. 2A and 2B. This transport unit 30, as shown in FIGS. 2A and 2B, includes a paper feed roller 31, a transport motor 32, a transport roller 33, a platen 34, and a paper discharge roller 35. When being supplied to the inside of the printer 10 by the paper feed roller 31, the medium S is transported to a printable area in the transport direction by the transport roller 33 that is rotated by the rotation of the transport motor 32. Thereafter, the medium S is intermittently transported by a regulated transport amount each time while being supported by the platen 34. Finally, the medium S is discharged outside the printer 10 by the paper discharge roller 35.

In addition, the transport unit 30 according to this embodiment can return the medium S back to the upstream side in the transport direction by rotating the transport roller 33 in a direction (reverse direction) opposite to the forward rotation direction. Accordingly, for example, after a background image is printed with ink of a color that is the same as that of the medium S, the medium S is returned to the upstream side in the transport direction, and a main image can be formed on the background image with ink of a different color.

The maintenance unit 40 is used for performing various maintenance operations so as to maintain good ink ejection from the nozzles. The maintenance unit 40, as shown in FIG. 2A, is located right below the head 23 when the head 23 is located in a position in which the nozzle face is located in a position (non-printing position, a standby position of the head 23), in which the nozzle face does not face the medium S, in the moving direction of the head 23. In addition, the maintenance unit 40, as shown in FIG. 1, includes a cap 41 and a suction pump 42. The cap 41 is brought into contact with the nozzle face of the head 23 so as to seal the nozzle (in particular, each nozzle hole). The suction pump 42 is operated in a state in which the cap 41 seals the nozzle. Accordingly, a negative-pressure state is formed inside the cap 41, and ink inside the nozzle is sucked and forcedly discharged.

As described above, the maintenance unit 40 performs an operation (cleaning operation) for forcedly discharging the ink inside the nozzles by using the suction pump 42 in a state in which the nozzles are sealed by the cap 41. By performing such a cleaning operation, the nozzle that is in the defective ink-ejection state due to clogging or the like is cleaned (the defective ink-ejection is eliminated). In addition, the above-described cleaning operation includes an operation for forcedly ejecting (so-called flushing) ink from each nozzle by driving the above-described piezo element in a state in which the nozzles are sealed by the cap 41, in addition to an operation for forcedly discharging the ink inside the nozzle by using the suction pump 42.

The controller 60 controls each unit (that is, the recording unit 20, the transport unit 30, and the maintenance unit 40) of the printer 10 through a unit control circuit 64 by using a CPU 62 in accordance with a program that is stored in a memory 63. The controller 60 can communicate with a computer 110 through an interface 61. When receiving print data from the computer 110, the controller 60 prints an image corresponding to the print data on a medium S by controlling each unit based on the print data. In addition, the state of the inside of the printer 10 is monitored by the detector group 50, and the detector group 50 outputs a signal corresponding to the detection result to the controller 60.

### <<Printing Process>

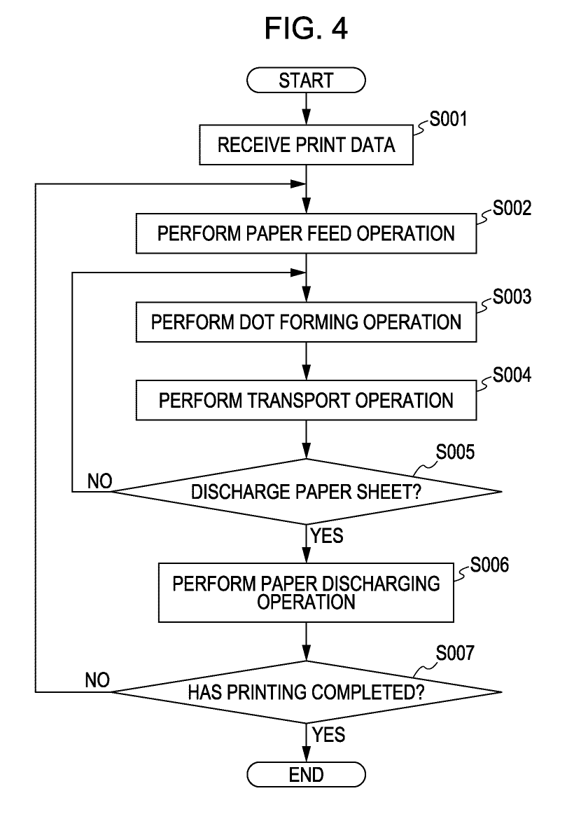

Next, a printing process that is performed by the printer 10 will be described with reference to FIG. 4. FIG. 4 is a flowchart of the printing process.

As shown in FIG. 4, the printing process is started as the controller 60 receives print data including a print command from the computer 110 through the interface 61 (S001). Then, the controller 60 analyzes the contents of various commands included in the received print data and controls each unit of the printer 10. Next, the controller 60 performs a paper feeding operation in which the medium S is supplied to the inside of the printer 10 by the paper feed roller 31 and then, the medium S is positioned in a print starting position (lead-out position) by the transport roller 33 (S002).

Next, the controller 60 performs a dot forming operation in which dots are formed on the medium S by intermittently ejecting ink from the nozzles of the head 23 that moves in accompaniment with the movement of the carriage 21 (S003). The dots are formed by landing ink droplets in a rectangular area (hereinafter, referred to as a unit area) that is virtually defined on the medium S. The size and the form of the unit area are determined based on the printing resolution. When ink droplets are ejected ideally, the ink droplets land in a center position of the unit area and then, spread, whereby dots are formed in the unit area. In the dot forming operation, ink is intermittently ejected from the nozzles of the moving head 23, and accordingly, a plurality of dot rows (raster lines) along the moving direction of the head 23 is formed on the medium S to be parallel to each other in the transport direction.

Next, the controller 60 performs a transport operation in which the medium S is moved in the transport direction relative to the head 23 by the transport unit 30 (S004). By performing the transport operation, a raster line can be formed by the next dot forming operation in a position different from the position of the raster line that was formed by the previous dot forming operation. The controller 60 repeats the dot forming operation and the transport operation, and whereby a plurality of the raster lines is formed in the transport direction. In this embodiment, an interlaced method in which the raster lines are complimentarily formed by a plurality of the dot forming operations (hereinafter, referred to as a pass) is used.

Then, the controller 60 repeats the dot forming operation and the transport operation until there is no more print data to be printed on the medium S and determines discharge of a paper sheet at the point in time when there is no print data (S005). Thereafter, the controller 60 performs a paper discharging operation in which the medium S is discharged outside the printer 10 by the paper discharge roller 35 (S006). After the medium S on which an image is printed is discharged outside the printer 10, the controller 60 determines whether to proceed to print (S007). When a printing operation is to be performed on the next medium S, the controller 60 returns to the above-described paper feeding operation and proceeds to print. On the other hand, when a printing operation is not to be performed for the next medium S, the printing process ends.

### <<Computer 110>>

Next, the computer 110 that is connected to the printer 10 will be described. The computer 110 outputs execution commands for various operations other than the print data to the printer 10 (for example, the cleaning operation), which are performed inside the printer 10. In this computer 110, as shown in FIG. 1, programs such as a printer driver 111, an application program 112, and the like are installed.

The printer driver 111 receives image data from the application program 112, converts this image data into print data, and outputs the print data to the printer 10. The print data includes data (hereinafter, referred to as pixel data) relating to pixels that constitute an image (print image) to be printed. The pixel data, for example, is data (data such as the color, the size, or the like of the dot) relating to dots that are formed in the unit area corresponding to a specific pixel.

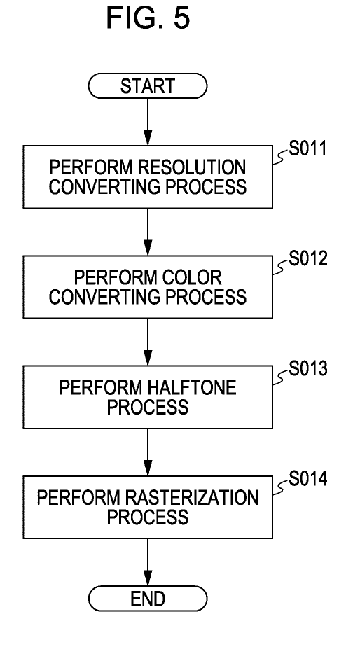

Hereinafter, a print data generating process performed by the printer driver 111 will be described with reference to FIG. 5. FIG. 5 is an explanatory diagram of the print data generating process. The print data, as shown in FIG. 5, is generated by performing a resolution converting process (S011), a color converting process (S012), a halftone process (S013), and a rasterization process (S014) by using the printer driver 111.

The resolution converting process is a process for converting the resolution of the RGB image data that is output from the application program 112 into the print resolution corresponding to a designated image quality. The color converting process is a process for converting the RGB image data, of which the resolution has been converted, into image data of four CMYK colors. The plurality of pixel data that constitutes the image data is represented by a gray scale value having one of 256 levels.

The halftone process is a process for converting a multi-level gray scale value of the pixel data into the fewer levels of dot gray scale value that can be represented by the printer 10. In other words, in the halftone process, 256 levels of gray scale value that is represented by the pixel data is converted into 4 levels of dot gray scale value. In particular, the gray scale value is converted into one of four levels that includes no-dot formation corresponding to a dot gray scale value [00], small dot formation corresponding to a dot gray scale value [01], a medium dot formation corresponding to a dot gray scale value [10], and a large dot formation corresponding to a dot gray scale value [11]. Thereafter, after a dot generating rate is determined for the size of each dot, the pixel data is generated by using a dither method, a γ correction method, an error diffusion method, or the like, so that the printer 10 forms the dots in a diffused pattern.

The rasterization process is a process relating to the image data that is acquired by performing the halftone process. The rasterization process is a process for changing the data of dots (data of dot gray scale values) in the order of data to be transmitted to the printer 10. Then, the rasterized data is transmitted as a part of the print data.

In addition, when a main image is formed on a background image after forming the background image, the printer driver 111 generates print data for the main image and print data for the background image in the above-described sequence and transmits the print data to the printer 10.

### <Setting by Using Printer Driver 111>

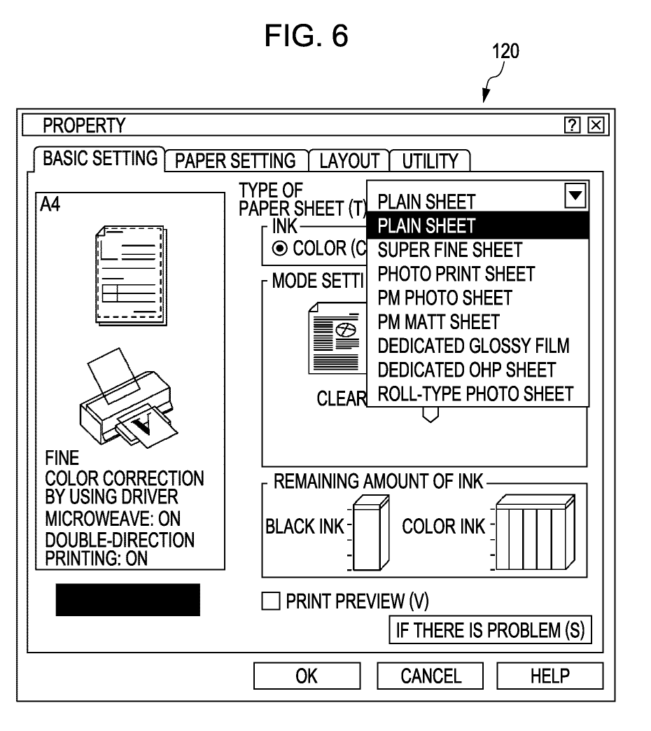

The printer driver 111, in order to accept a user's setting operation for the printing condition, displays a setting screen 120 shown in FIG. 6 in a display (not shown) of the computer 110. FIG. 6 is a diagram showing the setting screen 120. The user can select various printing conditions (the printing resolution or the type, the size, and the like of the medium S) through the setting screen 120. Then, the printer driver 111 generates the print data in accordance with the selected printing conditions.

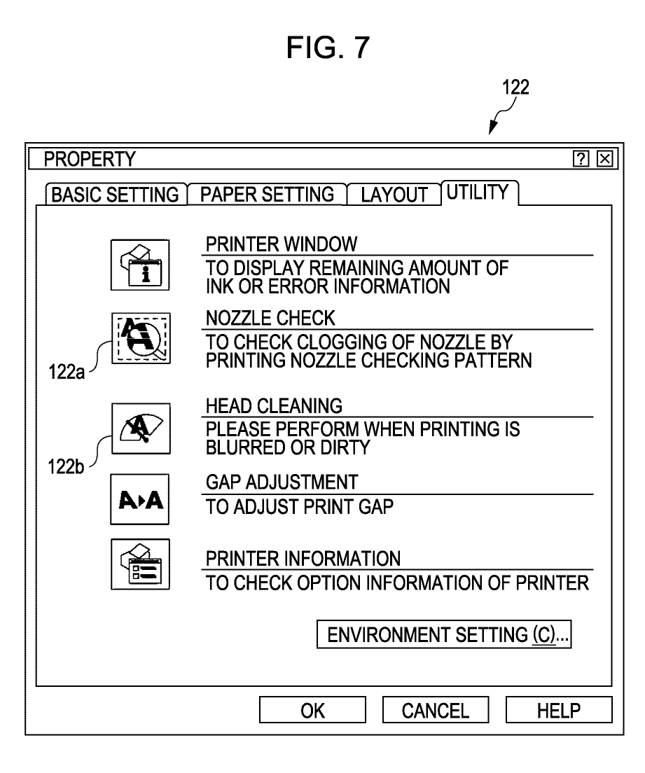

The setting screen 120 can be switched over in accordance with the type of the setting content. The setting screen 120 shown in FIG. 6 can be switched to a basic setting screen, a paper setting screen, a layout setting screen, or a utility setting screen. The user can allow the printer 10 to print a nozzle test pattern NP to be described later through the utility setting screen (hereinafter, referred to as a utility screen 122) of the setting screen 120 (see FIG. 7). Furthermore, the user can perform the cleaning operation by using the maintenance unit 40 through the utility screen 122.

### <<Nozzle Test Pattern>>

In printing an image on a medium S by using the printer 10, there are cases where ink is not ejected from a nozzle and a dot is not appropriately formed in a unit area in which the dot was to originally be formed. Such a case is referred to as a missing nozzle phenomenon and is one factor which decreases the quality of a printed image. The occurrence of the missing nozzle phenomenon means that the nozzle is in a defective ink-ejection state that is caused by nozzle clogging or the like.

In order to avoid deterioration of the image quality due to the above-described missing nozzle phenomenon, a user tests on a regular basis whether each nozzle can eject ink without any problem. When determining that the nozzle is in the defective ink-ejection state, the user performs the above-described cleaning operation.

For testing the defective ink-ejection of a test target nozzle, a process is performed for forming a nozzle test pattern NP on a predetermined medium (hereinafter, referred to as a test sheet TS) by landing ink ejected from the test target nozzle on the test sheet TS. The user tests whether the test target nozzle is in the defective ink-ejection state by visually recognizing the nozzle test pattern NP or the like. In other words, the nozzle test pattern NP is a pattern that is used for testing the defective ink-ejection (defective liquid-ejection) of the test target nozzle.

Hereinafter, a reference example of a method of forming the nozzle test pattern NP by using the printer 10 (hereinafter, may be simply referred to as a reference example) will be described. In addition, the problem in the reference example will be described.

### <<Reference Example>>

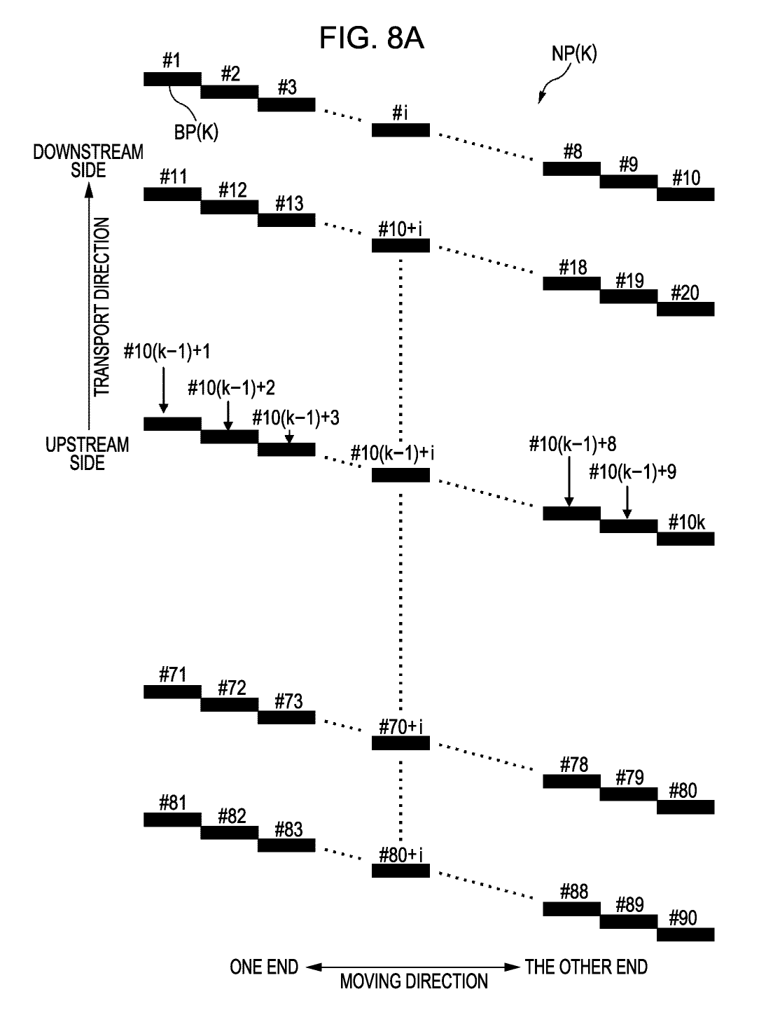

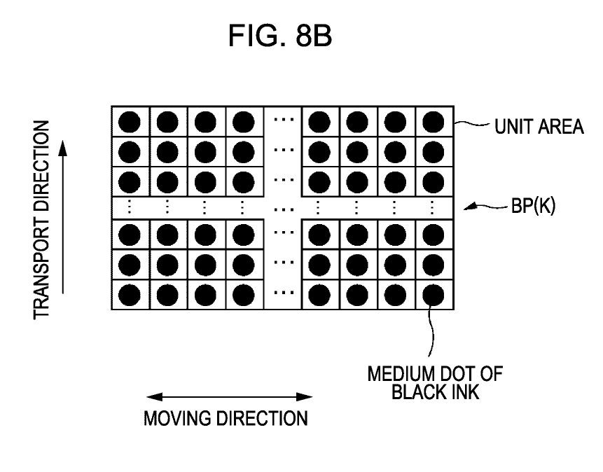

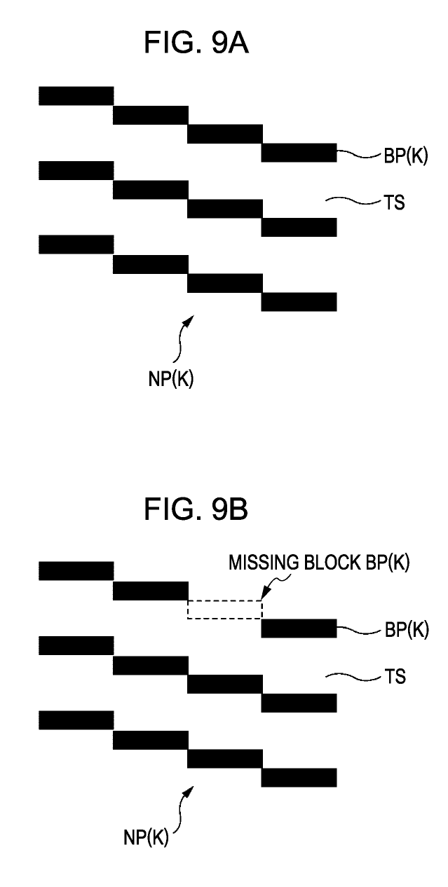

The reference example will be described with reference to FIGS. 7, 8A, 8B, 9A, and 9B. FIG. 7 is a diagram showing the above-described utility screen 122. FIG. 8A is a diagram showing the nozzle test pattern NP(K) that is used for testing the defective ink-ejection of a black ink nozzle. FIG. 8B is an enlarged diagram of one block BP(K) that constitutes the nozzle test pattern NP(K). FIGS. 9A and 9B are explanatory diagrams of a method of testing a nozzle by using the nozzle test pattern NP. FIG. 9A is a diagram for a case where the nozzle test pattern NP is appropriately formed, and FIG. 9B is a diagram for a case where a part of the nozzle test pattern NP is missing.

The controller 60 of the printer 10 uses one from a plurality of nozzles included in the head 23 as the test target nozzle and forms the nozzle test pattern NP of the test target nozzle by landing ink ejected from the test target nozzle on the test sheet TS. In addition, the controller 60 uses each nozzle from the plurality of nozzles as the test target nozzle and forms the nozzle test pattern NP of each nozzle. In the process of forming the nozzle test pattern NP according to the reference example, the nozzle test pattern NP of each nozzle is printed in a monochrome color with ink ejected from the nozzle. For example, the nozzle test pattern NP of the black ink nozzle is printed only with black ink.

Hereinafter, the sequence of forming the nozzle test pattern NP according to the reference example will be described. In addition, the sequence of forming the nozzle test pattern NP is the same for each nozzle. Thus, hereinafter, a case where the nozzle test pattern NP(K) is formed by using the black ink nozzle as the test target nozzle will be described as an example.

In forming the nozzle test pattern NP, a user sets a test sheet TS in the printer 10 and clicks on a nozzle testing button 122a (see FIG. 7) that is displayed on the utility screen 122. By this clicking operation, the printer driver 111 accepts a user's request, generates print data for forming the nozzle test pattern NP for each of the plurality of nozzles, and outputs the print data to the printer 10.

When receiving the above-described print data, the controller 60 repeats the dot forming operation and the transport operation, described above, based on the print data for the nozzle test pattern NP(K) of the black ink nozzle that is included in the above-described print data. In other words, the controller 60 forms the nozzle test pattern NP(K) of the black ink nozzle by landing black ink ejected from the black ink nozzle on the test sheet TS. Since the nozzle test pattern NP(K) of the black ink nozzle is formed with black ink, and the color of the nozzle test pattern is black.

In addition, the nozzle test pattern NP(K) of the black ink nozzle, as shown in FIG. 8A, is formed by blocks BP(K), the number of which is the same as the number (in this embodiment, 90) of nozzle holes configuring the black ink nozzle. Described in more detail, as shown in FIG. 8A, m (in the example shown in FIG. 8A, ten) rectangular blocks BP(K) are formed in the shape of stairs in the direction corresponding to the moving direction of the head 23 so as to be parallel to one another. In addition, n (in the example shown in FIG. 8A, nine) rectangular blocks are formed along the direction corresponding to the transport direction at constant intervals so as to be parallel to one another.

Each block BP(K), as shown in FIG. 8A, is surrounded by a background color portion of the test sheet TS. In other words, in the reference example, the nozzle test pattern NP(K) that is surrounded by the background color portion of the test sheet TS is formed. Here, the background color portion is a portion of the test sheet TS that is constituted by unit areas in which the controller 60 does not allow the ink to land.

In addition, each block BP(K) corresponds to one from the plurality of nozzle holes that constitutes the black ink nozzle and is formed by black ink that is ejected from the corresponding nozzle hole. When the correspondence relationship between the block BP(K) and the black ink nozzle hole is described, the block BP(K) that is located on the most downstream side in the transport direction and is located in one end side in the moving direction of the head 23 corresponds to the nozzle hole #1. In addition, as shown in FIG. 8A, the block BP(K) that is located in the i-th position viewed from the block BP(K) that is located on one end side in the moving direction of the head 23 and is located in the k-th position viewed from the block BP(K) that is located on the most downstream side in the transport direction corresponds to the nozzle hole #10(k−1)+i.

In addition, focusing on one from the plurality of blocks BP(K), as shown in FIG. 8B, the block BP(K) is formed by a plurality of dots including p dots aligned along the direction corresponding to the moving direction of the head 23 and q dots aligned along the direction corresponding to the transport direction. In addition, in the reference example, the dots constituting the block BP(K) are formed as medium dots. In other words, when the print data for the nozzle test pattern NP(K) is generated, the printer driver 111 sets the dot gray scale value of each pixel data that configuring the image data of the nozzle test pattern NP(K) to [10].

In addition, in one dot forming operation (an operation of moving the head 23 in the movement range from one end to the other end), one dot group of q dot groups (each dot group is formed by p dots aligned in the moving direction of the head 23) aligned in the transport direction is formed. Accordingly, in order to form q dot groups in the transport direction (in other words, in order to form the block BP(K)), the dot forming operation and the transport operation are alternately repeated q times. At that moment, q may be one when the block BP(K) is formed such that one dot is large and there is a need to easily check whether the dot is formed. In such a case, the block BP(K) is formed by performing the dot forming operation once.

After the nozzle test pattern NP(K) as described above is formed on the test sheet TS, the user tests defective ink-ejection of the black ink nozzle (that is, the test target nozzle) by visually recognizing the nozzle test pattern NP(K). In addition, as described above, the nozzle test pattern NP(K) is surround by the background color portion of the test sheet TS. Accordingly, when visually recognizing the nozzle test pattern NP(K), the user compares the color (that is, black) of ink that configures the nozzle test pattern NP(K) with the color of the background color portion (that is, the color of the test sheet TS).

Now, a method of testing the black ink nozzle will be described in detail. As shown in FIG. 9A, when a nozzle test pattern NP(K) that is formed by blocks BP(K), the number of which is the same as the number of nozzle holes of the black ink nozzle, is formed, it is determined that the black ink nozzle is normal. On the other hand, as shown in FIG. 9B, when a part of the nozzle test pattern NP(K) is missing, it is determined that the black ink nozzle is in the defective ink-ejection state. In other words, when a block BP(K) is not actually formed in a portion in which the block BP(K) of the nozzle test pattern NP(K) was to originally be formed on the test sheet TS, and the color of the portion is the background color of the test sheet TS, it is determined that missing nozzle phenomenon has occurred in a nozzle hole corresponding to the block BP(K) that has not formed.

Then, when it is determined that there is a nozzle in the defective ink-ejection state, the user clicks on the cleaning button 122b (see FIG. 7) that is displayed on the utility screen 122. By performing this clicking operation, the printer driver 111 accepts the user's request and outputs a command to the printer 10 for performing the cleaning operation by using the maintenance unit 40. When the command is received, the controller 60 of the printer 10 performs the above-described cleaning operation.

Thereafter, in order to check whether the defective ink-ejection of the nozzle is eliminated by performing the cleaning operation, the nozzle test pattern NP is printed on the test sheet TS again after the cleaning operation. The user repeatedly performs the cleaning operation and the formation of the nozzle test pattern NP until elimination of the defective ink-ejection has definitely been visually recognized.

### <<Problem in Reference Example>>

In the above-described sequence, each nozzle test pattern NP is formed (printed) on the test sheet TS with each of the plurality of nozzles (nozzles of five colors) used as the test target nozzle. Then, in the reference example, as described above, the nozzle test pattern NP of the test target nozzle is formed only with ink ejected from the test target nozzle (in other words, printed in a monochrome color).

On the other hand, as the test sheet TS on which the nozzle test pattern NP is to be formed, a plurality of types of media is used depending on the user's situation or the like. When the type of the test sheet TS is different, there are cases where there are changes in the visibility (easiness in visual recognition) of the nozzle test pattern NP that is formed on the test sheet TS. In other words, the visibility of the nozzle test pattern NP depends on the relationship between the color of ink that configures the nozzle test pattern NP and the type of the test sheet TS. A nozzle test pattern NP that is configured by ink of the color that cannot be easily identified in relation to the type of the test sheet TS, naturally, cannot be easily recognized by the user visually. For example, when a nozzle test pattern NP that is configured by ink of the white color is formed on a white test sheet TS, it is difficult to visually recognize the nozzle test pattern NP.

When a nozzle test pattern NP cannot be easily recognized by the user visually, it is difficult to appropriately test whether a nozzle (a test target nozzle) tested by using the nozzle test pattern NP is in the defective ink-ejection state. In other words, even when a nozzle test pattern NP is formed normally, there is a possibility that the user mistakenly recognizes that the nozzle test pattern NP is not formed (in other words, there is a possibility that a nozzle, which is in the normal state, is determined to be in the defective ink-ejection state). On the other hand, even when a part of a nozzle test pattern NP is not actually formed due to the defective ink-ejection, there is a possibility that the nozzle in the defective ink-ejection state is neglected in a state in which the user does not recognize the partial missing of the nozzle test pattern NP.

As described above, in the reference example, the above-described problem occurs since the nozzle test pattern NP that is configured by ink of the color that cannot be easily identified in relation to the type of the test sheet TS is formed. On the contrary, in the printer 10 according to this embodiment, by changing the sequence of forming the nozzle test pattern NP in accordance with the type of the test sheet TS, the nozzle test pattern NP of each nozzle can be appropriately formed. Hereinafter, a method of forming a nozzle test pattern according to this embodiment will be described.

### Method of Forming Nozzle Test Pattern According to this Embodiment

A method of forming a nozzle test pattern NP by using the printer 10 according to this embodiment will be overviewed. In the printer 10 according to this embodiment, similar to the reference example, the controller 60 sets one from a plurality of nozzles that is disposed in the head 23 as a test target nozzle and forms a nozzle test pattern NP of the test target nozzle by landing ink ejected from the test target nozzle on a test sheet TS. Then, when forming the nozzle test pattern NP, the controller 60 follows either of the two sequences.

The two sequences will now be described. According to one sequence, in forming a nozzle test pattern NP of the test target nozzle, the nozzle test pattern NP of the test target nozzle is formed by landing ink ejected from the test target nozzle and ink ejected from another nozzle from the plurality of nozzles that is different from the test target nozzle on the test sheet TS so as to overlap with each other. A process for forming the nozzle test pattern NP according to the above-described sequence will be referred to as a first process.

The other sequence is the same as that of the reference example. In the other sequence, the nozzle test pattern NP of the test target nozzle is printed in a monochrome color with ink ejected from the test target nozzle. In other words, only the ink that is ejected from the test target nozzle lands on the test sheet TS, and whereby the nozzle test pattern NP that is formed with the ink is formed. A process that forms the nozzle test pattern NP according to the above-described sequence will be referred to as a second process.

In addition, the first process can be again divided into a third process and a fourth process. The controller 60 performs either the third process or the fourth process as the first process. The third process and the fourth process will be described later.

In addition, the controller 60, same as in the reference example, sets each of the plurality of nozzles that is included in the head 23 as the test target nozzle and forms the nozzle test pattern NP for each of the plurality of nozzles. Then, the controller 60 forms each nozzle test pattern NP by performing either the first process (in particular, the third process or the fourth process) or the second process.

After each nozzle test pattern NP is formed, the user tests whether each of the plurality of nozzles is in the defective ink-ejection state by visually recognizing the nozzle test patterns NP. Then, when it is determined that, from the plurality of nozzles, a nozzle of one color or more is in the defective ink-ejection state, the user performs the cleaning operation by clicking on the cleaning button 122b (see FIG. 7). After the cleaning operation is performed, the user, as described above, performs the process for forming the nozzle test pattern again and repeatedly performs the cleaning operation and the formation of the nozzle test pattern until elimination of the defective ink-ejection of the nozzle can definitely be visually recognized.

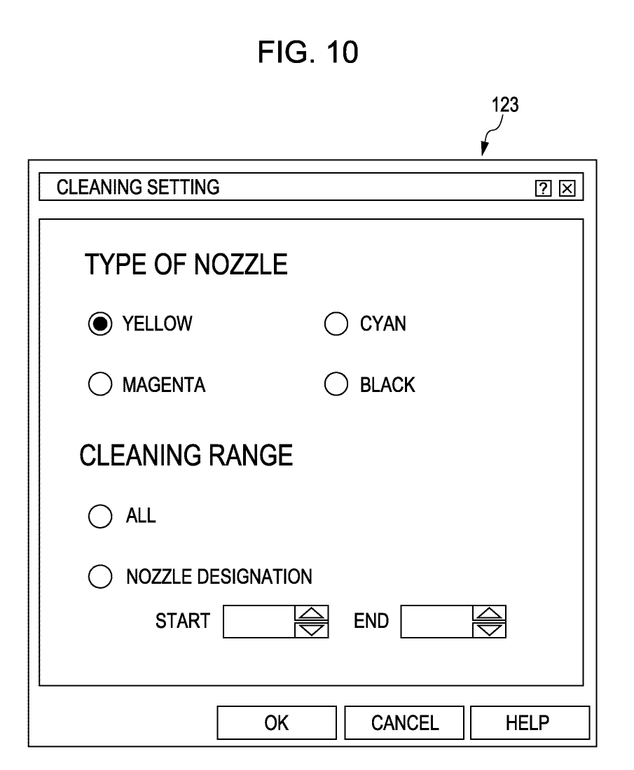

In addition, in the cleaning operation of this embodiment, all the plurality of nozzles (all the nozzles that are formed in the nozzle face of the head 23) is cleaned. However, the invention is not limited thereto. Thus, it may be configured that the cleaning operation is performed for the nozzle from among the plurality of nozzles that is in the defective ink-ejection state (in other words, the cleaning operation may be configured to be performed in units of nozzles). Alternatively, the cleaning operation may be performed only for a nozzle hole for which the missing nozzle phenomenon is determined to have occurred. For example, the printer driver 111 displays the cleaning setting screen 123 shown in FIG. 10 after the user clicks on the cleaning button 122b, and the cleaning operation may be performed under the conditions that are set by the user on the cleaning setting screen 123. FIG. 10 is a diagram showing the cleaning setting screen 123.

### <Third Process>

The third process is a process for mixing ink by landing ink ejected from the test target nozzle and ink ejected from another nozzle on the test sheet TS in an overlapping manner in forming the nozzle test pattern NP of the test target nozzle. The nozzle test pattern NP formed by performing the third process has a color that is acquired by mixing the ink ejected from the test target nozzle with the ink ejected from a different nozzle (that is, a color different from the color of the ink ejected from the test target nozzle). When the ink ejected from the test target nozzle has a color that cannot be easily identified in relation to the type of the test sheet TS (that is, a color that cannot be easily identified when compared with the background color of the test sheet TS), the color of the nozzle test pattern NP of the test target nozzle can be changed to a color that can be easily identified by the user by performing the third process.

In addition, the ink (that is, the ink to be mixed with the ink ejected from the test target nozzle) ejected from the different nozzle in the third process is ink of a color that is different from the color of the ink ejected from the test target nozzle. In addition, the ink ejected from the different nozzle is ink that improves the contrast of the color of the nozzle test pattern NP of the test target nozzle on the background color of the test sheet TS by being mixed with the ink ejected from the test target nozzle.

In order to describe the third process in detail, hereinafter, a case where the third process is performed by using the yellow ink nozzle as the test target nozzle and the cyan ink nozzle as the different nozzle will be described as an example.

When performing the third process for forming the nozzle test pattern NP of the yellow ink nozzle, the controller 60 mixes the yellow ink with the cyan ink by landing the yellow ink ejected from the yellow ink nozzle and the cyan ink ejected from the cyan ink nozzle on the test sheet TS in an overlapping manner. As a result, as the nozzle test pattern NP of the yellow ink nozzle, a nozzle test pattern NP (hereinafter, referred to as a mixed nozzle test pattern NP(CY)) from the mixed color (dark yellow-green) of yellow and cyan is formed.

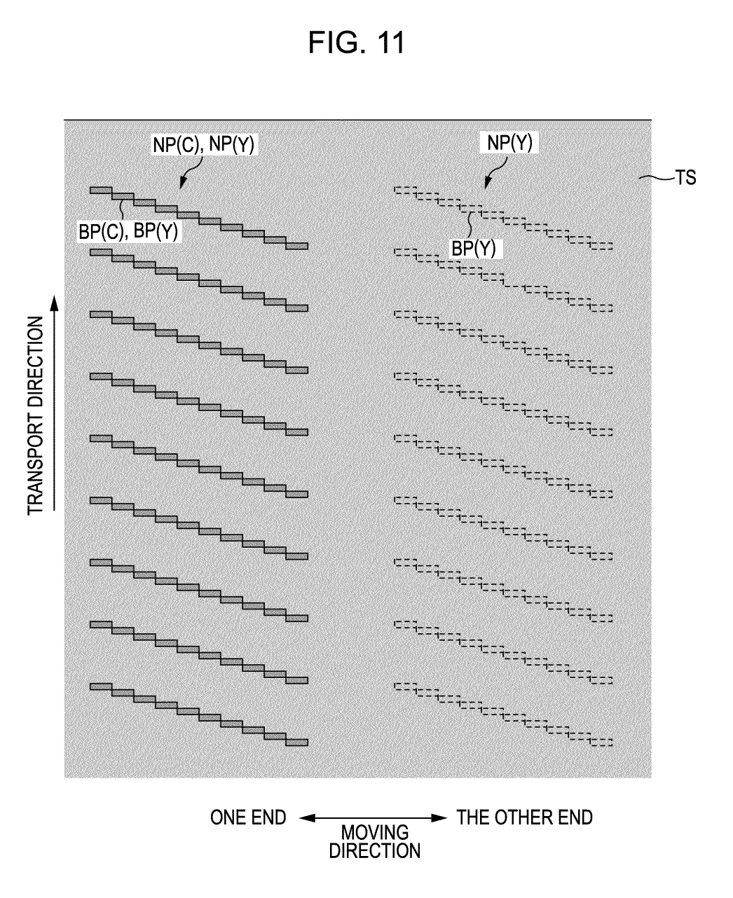

The mixed nozzle test pattern NP(CY), as shown in FIG. 11, is constituted by blocks BP (hereinafter, referred to as a mixed block BP(CY)), the number of which is the same as the number of nozzle holes configuring the yellow ink nozzle. FIG. 11 is a diagram showing the mixed nozzle test pattern NP(CY). In FIG. 11, to the side of the mixed nozzle test pattern NP(CY), as a comparative example, a nozzle test pattern NP(Y) is shown for the yellow ink nozzle that is printed in the monochrome color with the yellow ink.

In addition, as shown in FIG. 11, each mixed block BP(CY) is surrounded by the background color portion of the test sheet TS. In other words, the mixed nozzle test pattern NP(CY) that is surrounded by the background color portion is formed in the third process. In addition, the mixed block BP(CY) corresponds to one nozzle hole that configures the yellow ink nozzle. The correspondence relationship between the mixed block BP(CY) and the nozzle hole is the same as the above-described correspondence relationship.

Hereinafter, the flow for forming the mixed nozzle test pattern NP(CY) in the third process will be described. The controller 60 has the cyan ink ejected from the cyan ink nozzle land in a predetermined unit area after the head 23 has departed from one end of the moving range of the head 23. Here, the predetermined unit area is a unit area of the test sheet TS corresponding to the pixel data that constitutes the image data of the mixed nozzle test pattern NP(CY). Thereafter, the yellow ink nozzle faces the above-described predetermined unit area within a period until the head 23 reaches the other end by moving further toward the other end of the moving range. At this moment, the controller 60 lands yellow ink on the above-described predetermined unit area by ejecting the yellow ink from the yellow ink nozzle.

As described above, the controller 60 lands the yellow ink and the cyan ink land on the test sheet TS in an overlapping manner within one dot forming operation (one pass). In addition, the yellow ink and the cyan ink that land in an overlapping manner are ejected from a cyan ink nozzle hole and a yellow ink nozzle hole that are located in a same position in the transport direction. Described in more detail, in the position in which the cyan ink ejected from the cyan ink nozzle hole #k lands, yellow ink ejected from a yellow ink nozzle hole #k lands. In addition, the order of landing of each ink is not limited to the case where the yellow ink lands on the cyan ink in an overlapping manner after the cyan ink lands on the test sheet TS and, the above-described order may be reversed.

Then, the yellow ink and the cyan ink that land in the predetermined unit area are mixed together so as to form a dot (in particular, a dot of a dark yellow-green) of the mixed color of cyan and yellow in the predetermined unit area. As a result, the mixed nozzle test pattern NP(CY) that is formed by the dot of the mixed color is formed on the test sheet TS. In addition, by having the yellow ink and the cyan ink land on the test sheet TS in an overlapping manner during one pass, the yellow ink and the cyan ink are mixed well, compared to the case where the yellow ink and the cyan ink land on the test sheet TS during different passes.

The mixed nozzle test pattern NP(CY) formed in the above-described sequence has a color that can be more easily identified than the nozzle test pattern NP(Y) of the monochrome color of yellow in relation to the background color, for example, in case where the background color of the test sheet TS is yellow. Accordingly, the nozzle test pattern NP of the yellow ink nozzle, as shown in FIG. 11, can be easily recognized visually, compared to the case where the nozzle test pattern is printed in the monochrome color with the yellow ink. In addition, as described above, the mixed nozzle test pattern NP(CY) is surrounded by the background color portion of the test sheet TS. Thus, when visually recognizing the mixed nozzle test pattern NP(CY), the user compares the color of the mixed nozzle test pattern NP(CY) with the color of the background color portion.

In addition, according to this embodiment, the ejection amounts of the yellow ink and cyan ink which are to be mixed are set to be approximately the same. In other words, the ejection amounts are set such that the mixing ratio of the yellow ink to the cyan ink is about 50%. However, the invention is not limited thereto. Thus, the mixing ratio may be adjusted by having more of either the yellow ink or the cyan ink land on the test sheet TS. By adjusting the mixing ratio to an appropriate value, there is a case where the contrast of the color of the mixed ink over the background color of the test sheet TS is improved further. In such a case, it is preferable that the mixing ratio is appropriately adjusted so as to allow the mixed nozzle test pattern NP(CY) to be more easily recognized visually.

The mixed nozzle test pattern NP(CY) is used for testing the defective ink-ejection of both the yellow ink nozzle and the cyan ink nozzle. In other words, the controller 60 forms the mixed nozzle test pattern NP(CY) as a nozzle test pattern NP for testing the defective ink-ejection of both the test target nozzle and the different nozzle. Accordingly, by visually recognizing the mixed nozzle test pattern NP(CY), the user can simultaneously test whether both the yellow ink nozzle and the cyan ink nozzle are in the defective ink-ejection state. As a result, the nozzle test can be performed with high efficiency.

Described in detail, when the number of the mixed nozzle test pattern NP(CY), that is formed by the mixed blocks BP(CY), is the same as the number (that is, 90) of the nozzle holes configuring the yellow ink nozzle (or the cyan ink nozzle), it is determined that both the yellow ink nozzle and the cyan ink nozzle are normal. On the contrary, when a part of or the entire mixed blocks BP(CY) are not appropriately formed, the yellow ink nozzle (or the cyan ink nozzle) is determined to be in the defective ink-ejection state. The inappropriate formation of the mixed block BP(CY) indicates a case where the color of the mixed block BP(CY) is not the color acquired by mixing the yellow ink and the cyan ink (that is, a monochrome color of yellow or cyan, or the background color of the test sheet TS).

### <Fourth Process>

The fourth process is a process in which a nozzle test pattern NP formed by ink ejected from a test target nozzle is formed on a base by having the ink ejected from the test target nozzle land on the base after the base formed with ink from a different nozzle is formed by having the ink ejected from the different nozzle land on the test sheet TS. In the fourth process, the nozzle test pattern NP of the test target nozzle is formed so as to be surrounded by the base. Accordingly, even when the ink ejected from the test target nozzle has a color that cannot be easily identified in relation to the type of the test sheet TS (that is, a color that cannot be easily identified when compared to the background color of the test sheet TS), the nozzle test pattern NP of the test target nozzle becomes distinguished, and whereby the nozzle test pattern NP can be easily recognized by the user visually.

In addition, the ink (that is, the ink forming the base) ejected from the different nozzle in the fourth process is ink of a color of which the contrast with the background color of the test sheet TS is higher than that of the color of the ink ejected from the test target nozzle. In addition, in the viewpoint of having the nozzle test pattern NP that can be distinguished, it is preferable that the ink ejected from the different nozzle is ink of a color that has higher contrast with the background color.

In order to describe the fourth process in detail, hereinafter, a case where the fourth process is performed by using the white ink nozzle as the test target nozzle and the black ink nozzle as the different nozzle will be described as an example.

When performing the fourth process for forming the nozzle test pattern NP(W) of the white ink nozzle, first, the controller 60 has black ink ejected from the back ink nozzle land in a predetermined area of the test sheet TS. Here, the predetermined area is an approximately rectangular area that surrounds the nozzle test pattern NP(W) when the nozzle test pattern NP(W) is formed. Then, the controller 60 forms a background image BG that is formed with the black ink on the test sheet TS by coating the predetermined area in a monochrome color with black ink. The background image BG is an example of the above-described base and has the shape and the size that are the same as those of the predetermined area.

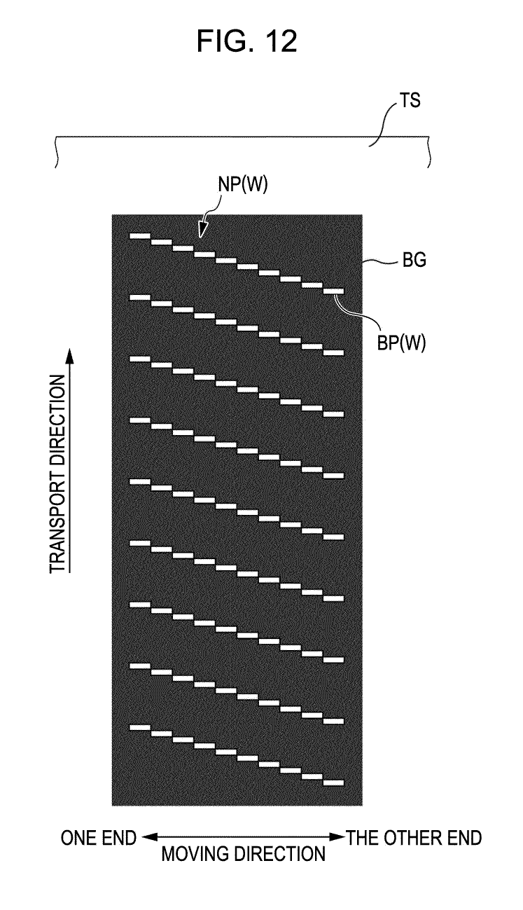

After the background image BG is formed, the controller 60 has white ink ejected from the white ink nozzle land on the background image BG. As a result, as shown in FIG. 12, the nozzle test pattern NP(W) that is surrounded by the background image BG and is formed with ink (white ink) ejected from the white ink nozzle is formed. FIG. 12 is a diagram showing the nozzle test pattern NP(W) that is formed on the background image BG.

The nozzle test pattern NP(W) of the white ink nozzle, as shown in FIG. 12, is constituted by blocks BP(W), the number of which is the same as the number of the nozzle holes configuring the white ink nozzle. Each block BP(W), as shown in FIG. 12, is formed in an island shape that floats on the background image BG The nozzle test pattern NP(W) of the white ink nozzle having such a shape has its periphery (in particular, the periphery of each block BP(W)) surrounded by the background image BG so as to be distinguishable. Accordingly, for example, when the background color of the test sheet TS is white, a nozzle test pattern NP(W) that is formed with white ink that cannot be easily identified in relation to the background color can be easily recognized by the user visually due to the background image BG.

In addition, when the background image BG is formed, in order to avoid the influence of a case where the missing nozzle phenomenon occurs in some of the black ink nozzle holes, it is preferable that the background image BG is formed by ejecting black ink from a plurality of the black ink nozzle holes.

In addition, in order to form the nozzle test pattern NP(W) of the white ink nozzle on the background image BG, for example, the test sheet TS may be located in a position in which the nozzle test pattern NP(W) of the white ink nozzle is formed on the background image BG by returning the test sheet TS to the upstream side in the transport direction by rotating the transport roller 33 in the reverse direction after the background image BG has been formed. Alternatively, it may be configured that a test sheet TS is discharged after the background image BG has been formed, and the test sheet TS is fed inside the printer 10 again.

### <<Flow of Process for Forming Nozzle Test Pattern>>

In this embodiment, when the nozzle test pattern NP of the test target nozzle is formed on the test sheet TS, the controller 60 performs the first process and the second process, described above, to be switched to each other in accordance with the type of the test sheet TS. In addition, the controller 60 sets each of the plurality of nozzles that is disposed in the head 23 as a test target nozzle and forms the nozzle test pattern NP for each of the plurality of nozzles. Then, when the nozzle test pattern NP for each of the plurality of nozzles is formed, the controller determines whether to perform the first process out of the first and second processes for forming the nozzle test pattern NP of the nozzle test patterns NP in accordance with the color of the test sheet TS as the type of the test sheet TS.

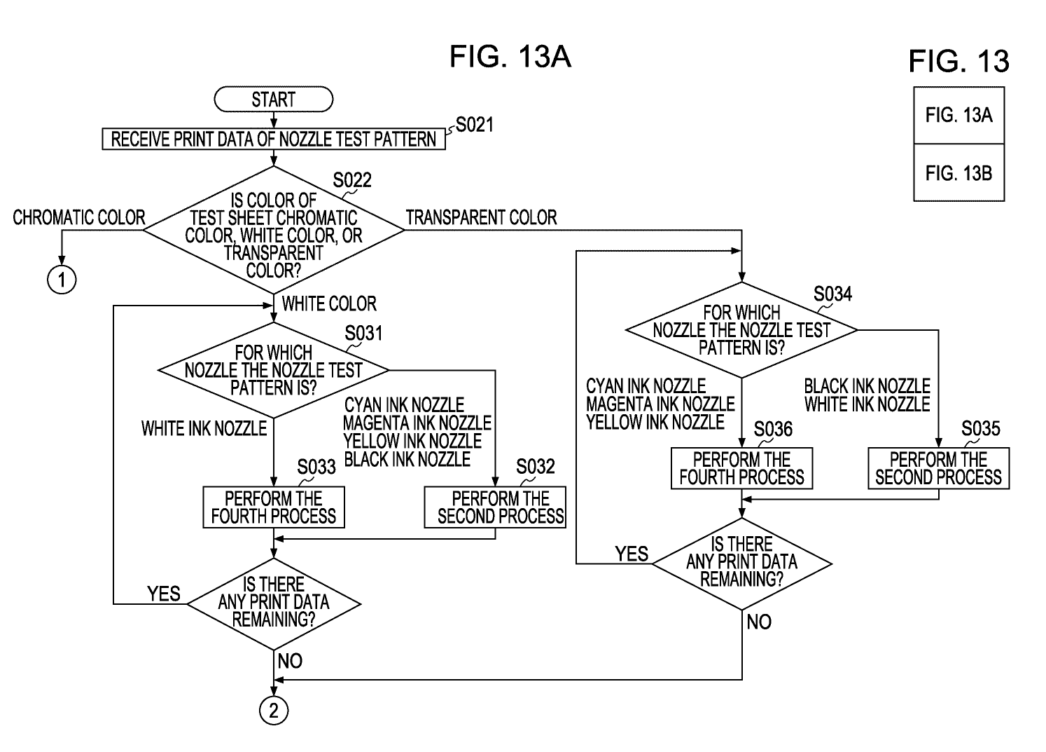

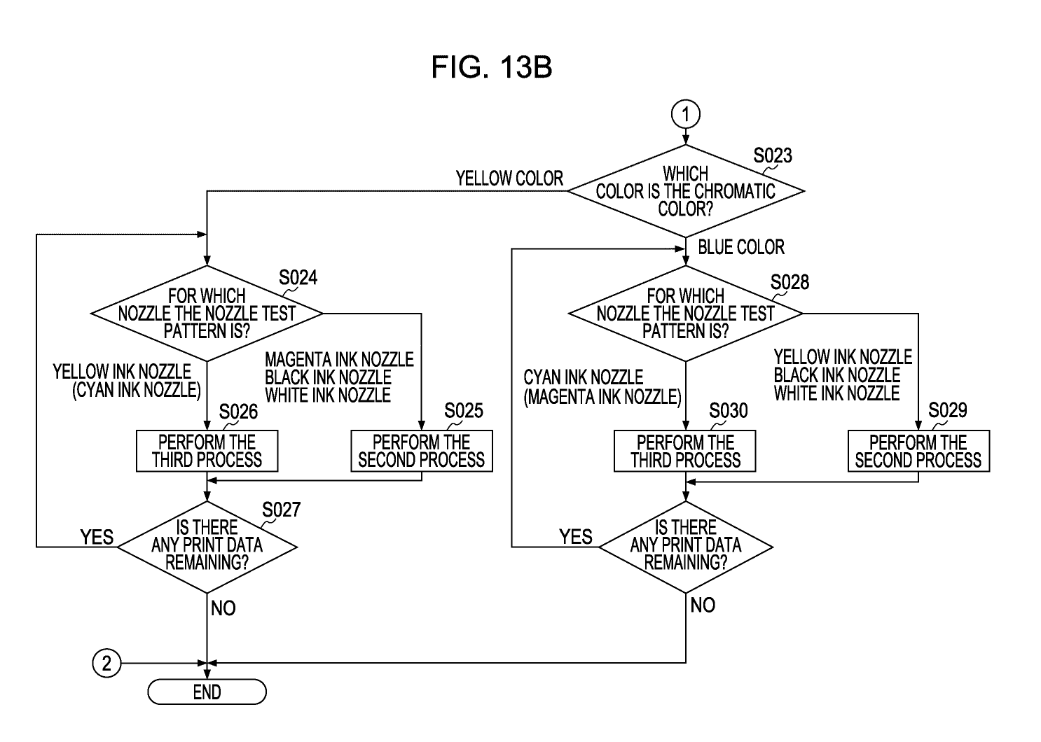

In order to describe the above-described content in detail, the flow of the process for forming the nozzle test pattern (the nozzle test pattern forming process) according to this embodiment will be described with reference to FIGS. 13 and 14. FIG. 13 is a diagram showing an example of the nozzle test pattern forming process according to this embodiment. In addition, FIG. 14 is a diagram showing the flow until the print data for the nozzle test pattern NP is transmitted after a user's request is accepted by the printer driver 111.

The nozzle test pattern forming process according to this embodiment, as shown in FIG. 13, is started as the controller 60 of the printer 10 receives print data for the nozzle test pattern NP from the printer driver 111 (S021). The print data is generated by setting each of the plurality of nozzles as the test target nozzle.

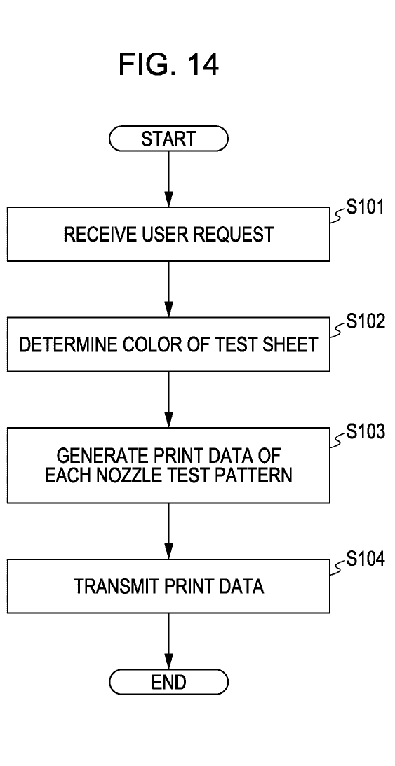

Described in more detail with reference to FIG. 14, when a user clicks on the nozzle testing button 122a, the printer driver 111 accepts a user's request (S101) and starts generating the print data for the nozzle test pattern NP. When generating the print data is started, the printer driver 111 displays a designation screen 124 shown in FIG. 15 that is used for the user to designate the color (background color) of the test sheet TS. FIG. 15 is a diagram showing the designation screen 124.

The user designates the color of the test sheet TS that is prepared in the above-described designation screen 124, and whereby the printer driver 111 determines the color of the test sheet TS (S102). In other words, according to this embodiment, when the nozzle test pattern NP is formed, the color of the test sheet TS is determined as the type of the test sheet TS. Then, the printer driver 111 generates the print data for each nozzle test pattern NP based on the determined color of the test sheet TS (S103). Thereafter, the printer driver 111 transmits the print data to the printer 10 (S104).

Here, the printer driver 111 generates the print data for the nozzle test pattern NP of the test target nozzle based on the color of ink ejected from the test target nozzle and the color of the test sheet TS as the determined type of the test sheet TS. Described in detail, the printer driver 111 selects one type of the print data from among the following three types of the print data as the print data for the nozzle test pattern NP of the test target nozzle based on the color of ink ejected from the test target nozzle and the color of the test sheet TS and generates the print data.

(1) print data for the nozzle test pattern NP that is formed only by the ink ejected from the test target nozzle

(2) print data for a mixed nozzle test pattern NP acquired by mixing ink ejected from the test target nozzle with ink ejected from a different nozzle

(3) print data for the nozzle test pattern NP that is surrounded by a background image BG formed with ink ejected from a different nozzle and is formed with ink ejected from the test target nozzle

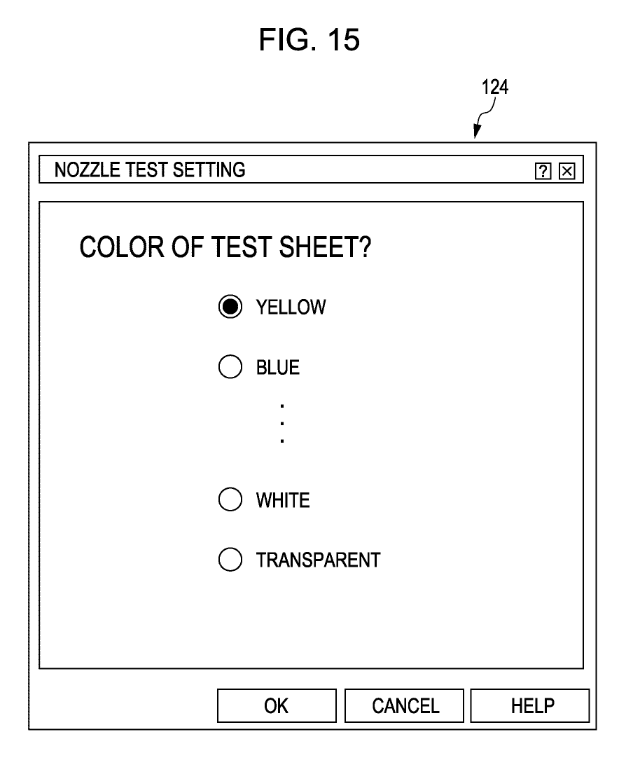

In addition, the correspondence relationship of the color of the ink ejected from the test target nozzle and the color of the test sheet TS and the type of the print data for the nozzle test pattern NP of the test target nozzle is as shown in FIG. 16. The information representing the correspondence relationship is stored in the memory (not shown) of the computer 110. FIG. 16 is a diagram showing the correspondence relationship of the type of the print data for the nozzle test pattern NP, the color of the ink ejected from the test target nozzle, and the color of the test sheet TS.

The printer driver 111 reads out the information representing the above-described correspondence relationship from the memory and generates the print data by selecting one type of the print data from among the above-described three types of the print data based on the correspondence relationship.

In addition, the ink (that is, the ink ejected from the different nozzle) that is used for being mixed with the ink ejected from the test target nozzle for forming the mixed nozzle test pattern or forming the background image BG, as shown in FIG. 16, is determined in advance based on the color of ink ejected from the test target nozzle and the color of the test sheet TS. In other words, the ink ejected from the different nozzle is changed based on the color of the ink ejected from the test target nozzle and the color of the test sheet TS.

For example, when the nozzle test pattern NP is formed on a yellow test sheet TS with the yellow ink nozzle set as the test target nozzle, cyan ink is used as the ink that lands on the test sheet TS so as to overlap with the ink (yellow ink) ejected from the yellow ink nozzle (in other words, the cyan ink nozzle is used as the different nozzle). Then, the print data for the mixed nozzle test pattern NP(CY) acquired by mixing the yellow ink and the cyan ink is generated.

In addition, when the nozzle test pattern NP is formed on a white test sheet TS with a white ink nozzle set as the test target nozzle, black ink is used as the ink that lands on the test sheet TS so as to overlap with the ink (white ink) ejected from the white ink nozzle (in other words, the black ink nozzle is used as the different nozzle). Then, the print data for the nozzle test pattern NP(W) that is surrounded by the background image BG formed with the black ink and formed with the white ink is generated.

Next, the controller 60 of the printer 10 repeats the dot forming operation and the transport operation based on the received print data and forms the nozzle test patterns NP on the test sheet TS with each of the plurality of the nozzles set as the test target nozzle.

Here, the type of the print data for each nozzle test pattern NP, as described above, is changed based on the color of the test sheet TS and the color of ink ejected from the test target nozzle. This will be described from the viewpoint of the controller 60.

When receiving the print data for each nozzle test pattern NP, the controller 60 generates the nozzle test pattern NP of the print data based on the print data. At this moment, the controller 60 performs either a first process or a second process as the process for forming the nozzle test pattern NP in accordance with the color of the test sheet TS as the type of the test sheet TS for each nozzle test pattern NP.

In other words, according to this embodiment, when forming the nozzle test pattern NP, the controller 60 determines whether to perform the first process of the first and second processes for forming the nozzle test pattern NP of the above-described nozzle test patterns NP in accordance with the color of the test sheet TS (S022 and S023 shown in FIG. 13). In other words, the controller 60 determines whether to perform the second process for forming the nozzle test pattern NP of the above-described nozzle test patterns NP in accordance with the color of the test sheet TS. Here, the color of the test sheet TS is the color of the test sheet TS that is determined by the printer driver 111 in accordance with the user's designation in the designation screen 124. Then, the controller 60 performs either the first process or the second process based on the color of the test sheet TS that is determined by the printer driver 111.

When performing the first process, the controller 60 performs either the third process or the fourth process described above. Then, the controller 60 determines whether to perform the third process or the fourth process for forming the nozzle test pattern NP, which is formed by the first process, of the above-described nozzle test patterns NP in accordance with the color of the test sheet TS as the type of the test sheet TS and the color of the ink ejected from the test target nozzle.

In addition, the controller 60 changes the color of the ink that lands on the test sheet TS so as to overlap with ink ejected from the test target nozzle in the third process and the fourth process, that is, the color of the ink ejected from the different target nozzle, based on the color of the test sheet TS as the type of the test sheet TS and the color of the ink ejected from the test target nozzle.

In order to describe the above-described content in more detail, cases where the nozzle test pattern NP is formed on each test sheet TS of a yellow test sheet TS, a blue test sheet TS, a white test sheet TS, and a transparent test sheet TS as the test sheet TS will be described.

### <Case Where Yellow Test Sheet TS Is Used>

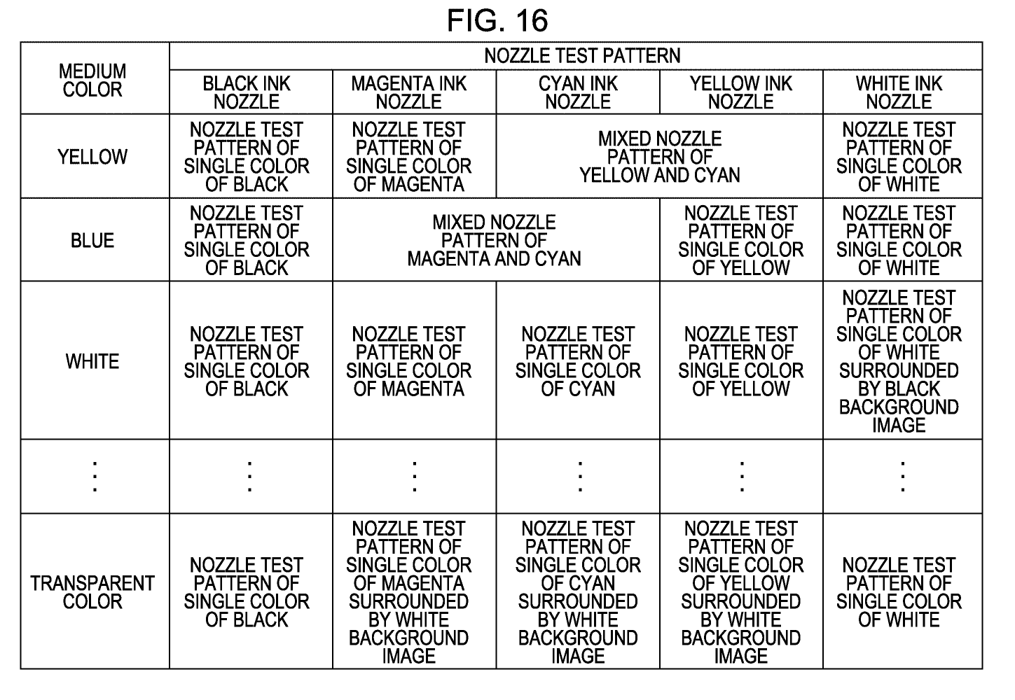

The test sheet TS used in this case is a medium having a chromatic background color. In particular, the test sheet TS is a yellow paper sheet. In this case, the controller 60, as shown in FIG. 13, performs the second process (S025) for a case where the nozzle test pattern NP is formed with each of the magenta ink nozzle, the black ink nozzle, and the white ink nozzle used as the test target nozzle from among the plurality of nozzles disposed in the head 23 (S024). In other words, the nozzle test pattern NP of each of the magenta ink nozzle, the black ink nozzle, and the white ink nozzle, as shown in FIG. 17, is printed in a monochrome color with ink ejected from the corresponding nozzle. FIG. 17 is a diagram showing each nozzle test pattern NP that is formed on the yellow test sheet TS.

On the other hand, when forming the nozzle test pattern NP with the yellow ink nozzle used as the test target nozzle (S024), as shown in FIG. 13, the controller 60 performs the third process of the first process (S026). In other words, when both the color of the test sheet TS and the color of the ink ejected from the test target nozzle are a chromatic color of a same color (in this case, yellow), the controller 60 has the ink ejected from the test target nozzle and the ink ejected from the different nozzle land on the test sheet TS in an overlapping manner, whereby mixing the ink. Here, the different nozzle is the cyan ink nozzle, and the yellow ink and the cyan ink are mixed together.

As a result, as shown in FIG. 17, a mixed nozzle test pattern NP(CY) is formed as the nozzle test pattern NP of the yellow ink nozzle. The mixed nozzle test pattern NP(CY) has a color (dark yellow-green color) acquired by mixing the yellow ink and the cyan ink. This color can be more easily identified in relation to the yellow test sheet TS than the monochrome color of yellow. Accordingly, the mixed nozzle test pattern NP(CY) as the nozzle test pattern NP of the yellow ink nozzle can be more easily recognized visually by the user than the nozzle test pattern NP that is printed with the yellow ink in the monochrome color.

In addition, as described above, the mixed nozzle test pattern NP(CY) is also a pattern for testing defective ink-ejection of the cyan ink nozzle (the different nozzle). Accordingly, as shown in FIG. 17, the nozzle test pattern NP(M) of the magenta ink nozzle, the nozzle test pattern NP(K) of the black ink nozzle, the nozzle test pattern NP(W) of the white ink nozzle, and the mixed nozzle test pattern NP(CY) are formed at a time point when the dot forming operation and the transport operation are repeated until there is no more print data (S027). In other words, in this case, four nozzle test patterns NP are formed with each of nozzles of five colors set as the test target nozzle. Accordingly, the user visually recognizes four nozzle test patterns in testing nozzles of five colors.

### <Case Where Blue Test Sheet TS is Used>

The test sheet TS used in this case is a medium having a chromatic background color. In particular, the test sheet TS is a blue paper sheet. In this case, the controller 60, as shown in FIG. 13, performs the second process for a case where the nozzle test pattern NP is formed with each of the yellow ink nozzle, the black ink nozzle, and the white ink nozzle used as the test target nozzle (S028 and S029).

On the other hand, when forming the nozzle test pattern NP with the cyan ink nozzle used as the test target nozzle, the controller 60 performs the third process (S030). In other words, when both the color of the test sheet TS and the color of the ink ejected from the test target nozzle are a chromatic color of a blue color, the controller 60 has the ink ejected from the test target nozzle and the ink ejected from the different nozzle land on the test sheet TS in an overlapping manner, whereby mixing the ink. Here, the different nozzle is the magenta ink nozzle, and the cyan ink and the magenta ink are mixed together.

As a result, a nozzle test pattern NP (hereinafter, referred to as a mixed nozzle test pattern NP(CM)) of a mixed color of cyan and magenta is formed as the nozzle test pattern NP of the cyan ink nozzle. The mixed nozzle test pattern NP(CM) has a color (red) that can be more easily identified by the user in relation to the color of the test sheet TS. Accordingly, the mixed nozzle test pattern NP(CM) can be more easily recognized visually by the user than the nozzle test pattern NP that is printed with the cyan ink in the monochrome color.

In addition, the mixed nozzle test pattern NP(CM) is also a pattern for testing defective ink-ejection of the magenta ink nozzle (the different nozzle). Accordingly, also in this case, similarly to the case where the yellow test sheet TS is used, four nozzle test patterns NP are formed with each of nozzles of five colors set as the test target nozzle. Accordingly, the user visually recognizes four nozzle test patterns in testing nozzles of five colors.

### <Case Where White Test Sheet TS Is Used>

The test sheet TS used in this case is a medium having a white background color same as a plain sheet. In this case, the controller 60, as shown in FIG. 13, performs the second process for a case where the nozzle test patterns NP are formed with each of the nozzles of four colors CMYK set as the test target nozzle (S031 and S032).

On the other hand, when forming the nozzle test pattern NP with the white ink nozzle used as the test target nozzle, the controller 60 performs the fourth process of the first process (S033). In other words, when both the color of the test sheet TS as the type of the test sheet TS and the color of the ink ejected from the test target nozzle are a white color, the controller 60, first, forms a background image BG that is formed with ink (black ink) ejected from the black ink nozzle as the different nozzle. Thereafter, the controller 60 has the white ink, which is ejected from the white ink nozzle, land on the background image BG.

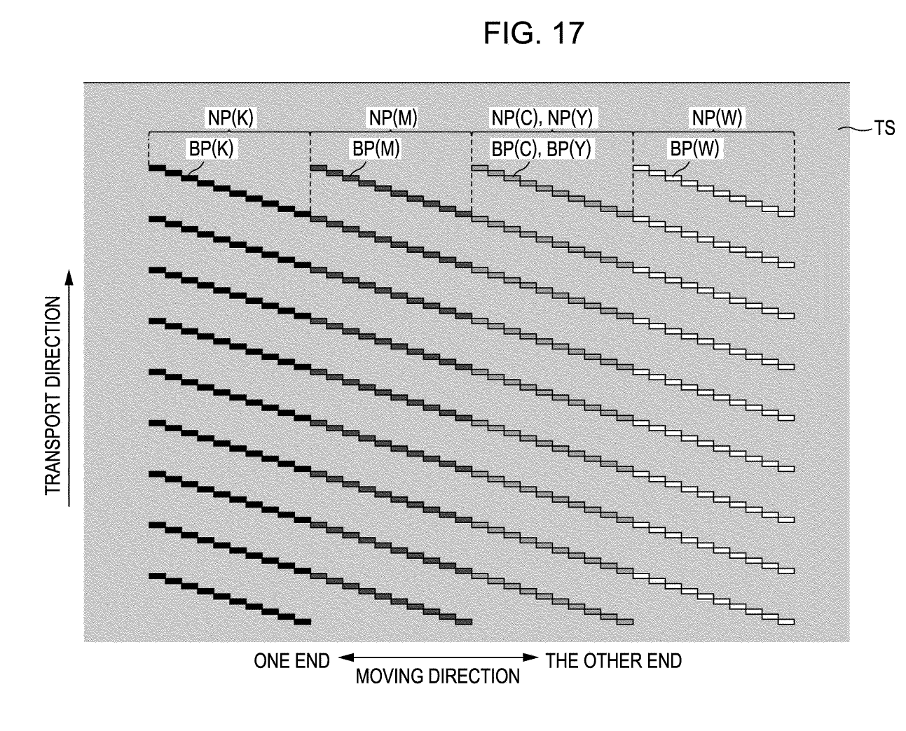

As a result, as shown in FIG. 18, a nozzle test pattern NP(W) that is surrounded by the background image BG and is formed with white ink is formed. FIG. 18 is a diagram showing each nozzle test pattern NP that is formed on the white test sheet TS. Since the nozzle test pattern NP(W) of the white ink nozzle is surrounded by the background image BG, the nozzle test pattern NP(W) is distinguished in relation to the color (that is, white) of the test sheet TS. As a result, the nozzle test pattern NP(W) of the white ink nozzle can be easily recognized by the user visually.

### <Case Where Transparent Test Sheet TS Is Used>

The test sheet TS used in this case is a medium having a transparent background, that is, a transparent medium such as a non-colored transparent film sheet. In this case, the controller 60, as shown in FIG. 13, performs the second process when the nozzle test patterns NP are formed with each of the black ink nozzle and the white ink nozzle set as the test target nozzle (S034 and S035).

On the other hand, when the nozzle test patterns NP are formed with each of the cyan ink nozzle, the magenta ink nozzle, and the yellow ink nozzle set as the test target nozzle, the controller 60 performs the fourth process (S036). In other words, when the test sheet TS is a transparent medium (in other words, the color of the test sheet TS is a transparent color) and the color of the ink ejected from the test target nozzle is a chromatic color, the controller 60, first, forms a background image BG that is formed with ink (white ink) ejected from the white ink nozzle as the different nozzle. Thereafter, the controller 60 has the ink (the cyan ink, the magenta ink, and the yellow ink), which is ejected from each test target nozzle, land on the background image BG.

As a result, nozzle test patterns NP(C), NP(M), and NP(Y) that are surrounded by the background image BG and are formed with ink ejected from the test target nozzles are formed. When ink of a chromatic color directly lands on the transparent test sheet TS, the ink cannot be easily identified. However, the nozzle test patterns NP(C), NP(M), and NP(Y) that are formed with ink of chromatic colors are surrounded by the background image BG so as to be distinguishable. Accordingly, the nozzle test patterns NP(C), NP(M), and NP(Y) can be easily recognized by the user visually.

In addition, in this case, when the nozzle test pattern NP is formed with the black ink nozzle set as the test target nozzle, the second process is performed. However, the invention is not limited thereto. Thus, the nozzle test pattern NP of the black ink nozzle may be formed by performing the fourth process.

### Effectiveness of Printer 10 of This Embodiment

As described above, according to the printer 10 of this embodiment, the controller 60 performs either the first process or the second process as the process for forming the nozzle test pattern NP of the test target nozzle in accordance with the type (in particular, the background color of the test sheet TS) of the test sheet TS on which the nozzle test pattern NP is formed.

In the first process, by having the ink ejected from the test target nozzle and the ink ejected from the different nozzle land on the test sheet TS in an overlapping manner, the color of the nozzle test pattern NP of the test target nozzle can be changed into a color that can be more easily identified, or the nozzle test pattern NP of the test target nozzle can be distinguished visually. Accordingly, the first process is useful for a case where the ink ejected by the test target nozzle has a color that cannot be easily identified in relation to the type of the test sheet TS.

On the other hand, the second process is a process for forming the nozzle test pattern NP that is formed only with the ink ejected by the test target nozzle. Accordingly, having the ink land on the test sheet TS in an overlapping manner and the like are not needed in the second process, unlike in the first process. Therefore, the second process is performed in an easier manner. As a result, the second process is effective for a case where the ink ejected by the test target nozzle has a color that can be easily identified in relation to the type of the test sheet TS.

In addition, by performing either the first process or the second process in accordance with the type of the test sheet TS, the nozzle test pattern NP of the test target nozzle can be formed by performing an appropriate process of the first and second processes in relation to the type of the test sheet TS. In other words, according to the printer 10 of this embodiment, the nozzle test pattern NP is appropriately formed in accordance with the type of the test sheet TS.

In addition, as can be known from the above-described four cases, according to this embodiment, the controller 60 forms the nozzle test patterns NP with each of the plurality of nozzles, which is disposed in the head 23, set as the test target nozzle and determines whether to perform the first process of the first and second processes for forming the nozzle test pattern of the above-described nozzle test patterns in accordance with the type of the test sheet TS. Accordingly, the process for forming the nozzle test pattern NP can be performed by one out of the first and second processes that is determined to be more appropriate in relation to the type of the test sheet TS for each nozzle forming pattern. As a result, the nozzle test patterns NP for the plurality of nozzles are appropriately formed in accordance with the type of the test sheet TS. However, the invention is not limited thereto. Thus, for example, as a process for forming the nozzle test patterns NP, which out of either the first process or the second processes will be performed may be determined for a plurality of nozzles.

In addition, as can be known from the above-described four cases, the controller 60 performs either the third process or the fourth processes as the first process, and performs either the third process or the fourth process for forming the nozzle test pattern NP, which is formed by the first process, of the test patterns NP in accordance with the type of the test sheet TS and the color of the ink ejected from the test target nozzle. Accordingly, it is possible to form the nozzle test pattern NP, which is formed by the first process, so as to be more easily recognized visually based on the type of the test sheet TS and the color of the ink ejected from the test target nozzle.

### Second Embodiment

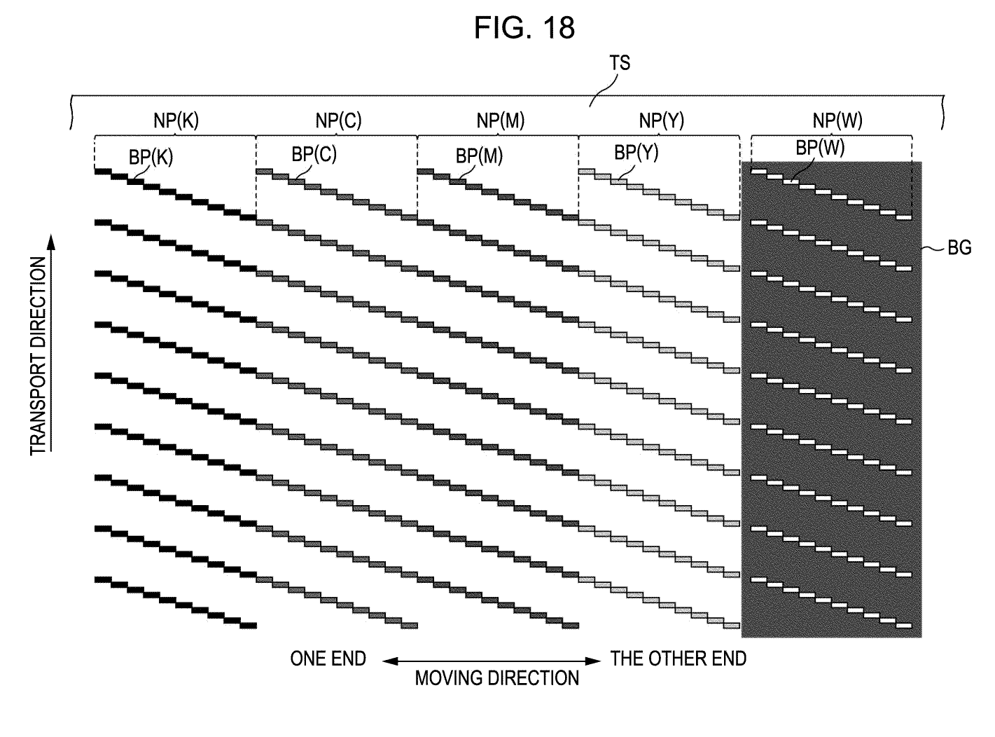

In the above-described embodiment (hereinafter, referred to as a first embodiment), the printer driver 111 accepts the user's operation on the designation screen 124, and thereby the color of the test sheet TS as the type of the test sheet TS is determined. However, a method of determining the color of the test sheet TS is not limited thereto. Thus, a different example (hereinafter, referred to as a second embodiment) may be considered. Hereinafter, a printer 10 according to a second embodiment of the invention will be described with reference to FIG. 19. FIG. 19 is a block diagram showing the entire configuration of the printer 10 according to the second embodiment.

The printer 10 of the second embodiment, as show in FIG. 19 has a color measuring device 51 installed therein as one of detectors. This color measuring device 51 is a device for measuring the color of the test sheet TS. The color measuring device 51 of this embodiment is a spectroscopic color-measuring system that measures the color of a predetermined range of the test sheet TS so as to acquire the measured color value of the predetermined range. In addition, the color measuring device 51 is installed in a position located on the upstream side in the transport direction relative to a position in which the paper discharge roller 31 is disposed. However, the installed position of the color measuring device 51 is not limited thereto.

According to the second embodiment, similar to the first embodiment, when a user clicks on the nozzle testing button 122a in a state in which the test sheet TS is set, the printer driver 111 generates print data for each nozzle test pattern NP. In starting to generate the print data, the printer driver 111 outputs a command for measuring the color of the set test sheet TS to the printer 10. When receiving the command, the controller 60 of the printer 10 measures the color of the test sheet TS by using the color measuring device 51 and outputs information representing the measured color value toward the printer driver 111. After receiving the information representing the measured color value, the printer driver 111 generates the print data for each nozzle test pattern NP based on the information representing the measured color value and transmits the print data to the printer 10.

When receiving the print data, the controller 60 of the printer 10 forms nozzle test patterns NP on the test sheet TS based on the print data. At this moment, the controller 60 performs either the first process or the second process as the process for forming the nozzle test pattern NP based on the color (that is, the measured color value of the test sheet TS) measured by the color measuring device 51 for each nozzle test pattern NP.

In addition, the controller 60 determines whether to perform the first process out of the first and second processes for forming the nozzle test pattern NP of the above-described nozzle test patterns NP in accordance with the color measured by the color measuring device 51. Then, the controller 60 determines whether to perform the third process or the fourth process for forming the nozzle pattern NP of the above-described nozzle patterns NP, which is formed by performing the first process, in accordance with the color measured by the color measuring device 51 and the color of the ink ejected from the test target nozzle.

As described above, according to the second embodiment, the type of the test sheet TS is the color measured by the color measuring device 51. By measuring the color of the test sheet TS by using the color measuring device 51, the color of the test sheet TS is determined. Then, the controller 60 of the printer 10 performs either the first process or the second process in accordance with the color measured by the measuring device 51. Accordingly, the color of the test sheet TS can be determined accurately, and whereby the nozzle test pattern NP can be more appropriately formed in accordance with the color of the test sheet TS. From such a viewpoint, the second embodiment may be preferably used.

On the other hand, the printer 10 according to the second embodiment includes the color measuring device 51, and accordingly, the printer 10 has a configuration that is more complicated than that of the first embodiment so as to increase the costs. Accordingly, in the viewpoint that the device is simplified and the manufacturing cost is suppressed, the first embodiment may be preferably used.

### Third Embodiment

In the first embodiment, a case where the background image BG is formed as a base that is formed with ink ejected from the different nozzle has been described. Thereafter, by having the ink ejected from the test target nozzle land on the background image BG, the nozzle test pattern NP that is surrounded by the background image BG and is formed with the ink ejected from the test target nozzle is formed. However, a case where a base that is different from the background image BG is formed (hereinafter, referred to as a third embodiment) may be considered. Hereinafter a third embodiment of the invention will be described. In description below, a case where the test target nozzle is the white ink nozzle, the different nozzle is the black ink nozzle, and a nozzle test pattern NP(W) of the white ink nozzle is formed on the white test sheet TS will be described as a detailed example.

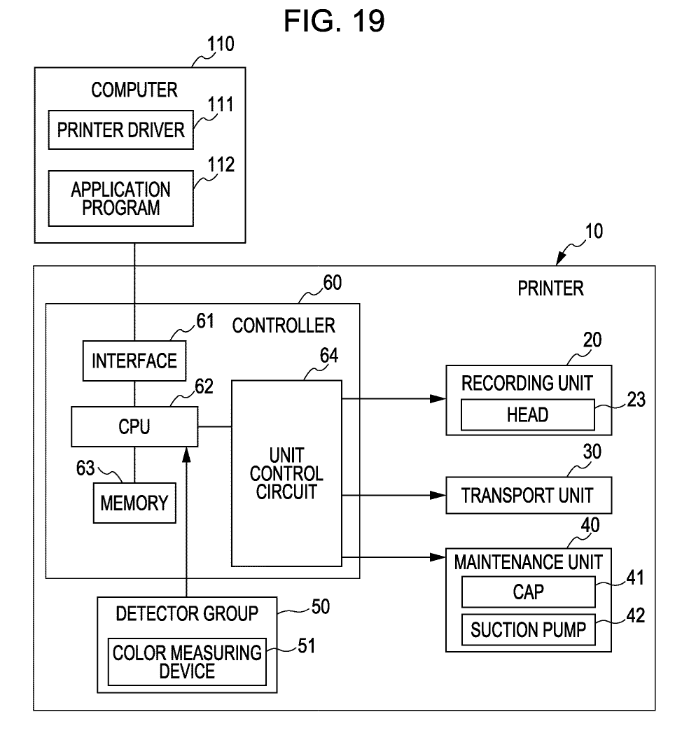

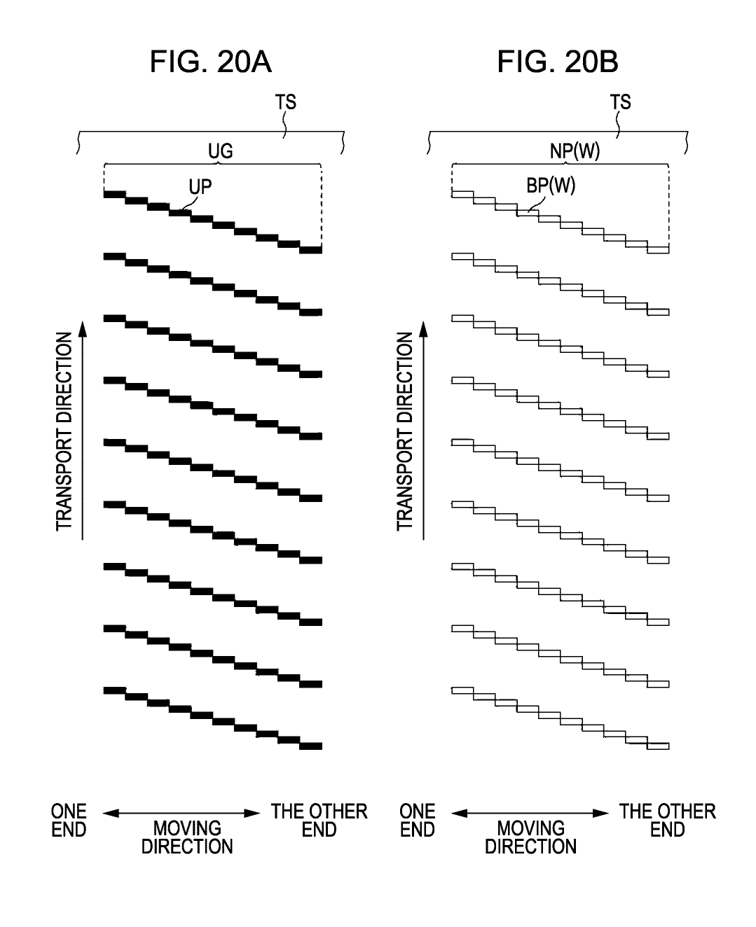

According to the third embodiment, the controller 60 has the ink (black ink) ejected from the black ink nozzle land on a predetermined unit area of the test sheet TS, and whereby a base pattern UG shown in FIG. 20A is formed. Here, the predetermined unit area is a unit area corresponding to pixel data that configures the image data of the nozzle test pattern NP(W) of the white ink nozzle. In addition, FIG. 20A is a diagram showing the base pattern UG

Hereinafter, the base pattern UG will be described in detail with reference to FIG. 20A. The base pattern UG corresponds to a base according to the third embodiment. This base pattern UG is formed in an area in which the test pattern NP(W) of the white ink nozzle was to originally be formed and is formed with ink (black ink) ejected from the black ink nozzle. In addition, the base pattern UG has a shape that is the same as that of the nozzle test pattern NP(W). The base pattern UG is configured by base pieces UP, the number of which is the same as the number of nozzle holes that configure the white ink nozzle. In the base pattern UG, the base pieces UP are arranged in a same manner as that of the blocks BP in the nozzle test pattern NP, as shown in FIG. 20A.

After forming the base pattern UG, the controller 60 coats with ink (white ink) ejected from the white ink nozzle on the base pattern UG in an overlapping manner. As a result, as shown in FIG. 20B, the nozzle test pattern NP(W) of the white ink nozzle is formed so as to cover the base pattern UG Described in more details, each block BP(W) that constitutes the nozzle test pattern NP(W) covers a corresponding base piece UP among the plurality of base pieces UP configuring the base pattern UG FIG. 20B is a diagram showing the nozzle test pattern NP(W) of the white ink nozzle that is formed on the base pattern UG.

As described above, according to the third embodiment, the base pattern UG having the same pattern as the nozzle test pattern NP(W) of the white ink nozzle is formed, and the nozzle test pattern NP(W) of the white ink nozzle is formed on the base pattern UG After the nozzle test pattern NP(W) is formed, test of defective ink-ejection of the white ink nozzle is performed in the sequence that is different from the test sequence of the first embodiment.

Described in detail, when the nozzle test pattern NP(W) covers the base pattern UG, it is determined that all the white ink nozzles are normal. In other words, when the base pattern UG is not visually recognized, the white ink nozzles are determined to be normal. On the contrary, when the nozzle test pattern NP(W) of the white ink nozzle does not cover the base pattern UG, it is determined that the white ink nozzle is in the defective ink-ejection state. In other words, when there is a block BP(W) that does not cover the base pattern UG (in particular, the base piece UP) in the nozzle test pattern NP(W), it is determined that the missing nozzle phenomenon has occurred in the white ink nozzle hole corresponding to the block BP(W).

As described above when the base pattern UG is formed as the base, the nozzle test pattern NP(W) of the white ink nozzle, although it is not distinguished, is formed in a state appropriate for testing the defective ink-ejection of the white ink nozzle. In addition, the amount of black ink consumed for forming the base as the base pattern UG is smaller than that consumed for forming the base as the background image BG From such a viewpoint, the third embodiment may be preferably used. On the other hand, from the viewpoint that the nozzle test pattern NP(W) of the white ink nozzle can be distinguished, the first embodiment may be preferably used.

### Other Embodiments

As above, a liquid ejecting apparatus and a method of forming a nozzle test pattern according to embodiments of the invention have been described. However, the above-described embodiments are not for limiting the scope of the invention but for easy understanding of the invention. The invention may be changed or modified without departing from the basic idea thereof, and equivalents of the invention also belong to the scope of the invention.

In particular, the color of the ink ejected from the test target nozzle and the color of the test sheet TS are not limited to the above-described embodiments. Thus, different colors may be used. For example, a nozzle for ejecting ink of light cyan (LC), a nozzle for ejecting ink of light magenta (LM), a nozzle for ejecting ink of light yellow (LY), a nozzle for ejecting ink of dark yellow (DY), a nozzle for ejecting ink of light black (LK), and the like may be further disposed on the nozzle face of the head 23, in addition to the nozzles of CMYK colors and the nozzle of white ink. In addition, when the controller 60 forms the nozzle test patterns NP with each of the above-described nozzles set as the test target nozzle, the controller 60 may be configured so as to perform either the first process or the second process in accordance with the type of the test sheet TS.

In addition, in the above-described embodiment, the nozzle test pattern NP that is formed by the third process is the nozzle test pattern NP that is used for testing both the defective ink-ejection of the test target nozzle and the defective ink-ejection of the different nozzle. In other words, in the above-described embodiment, the nozzle test patterns NP of the test target nozzle and the different nozzle are formed together in the third process. However, the invention is not limited thereto. Thus it may be configured that the nozzle test pattern NP of the test target nozzle and the nozzle test pattern NP of the different nozzle are formed independently.

In addition, in the above-described embodiment, the controller 60 performs either the third process or the fourth process as the first process. However, the invention is not limited thereto. Thus, both the third process and the fourth process may be configured to be performed as the above-described first process. For example, in the above-described embodiment, when the nozzle test pattern NP is formed on the test sheet TS as a transparent medium with the yellow ink nozzle set as the test target nozzle, the background image BG that is formed with white ink is formed, and the nozzle test pattern NP that is surrounded by the background image BG and is formed with yellow ink is formed (in other words, the fourth process is performed). Here, in order to have the nozzle test pattern NP of the yellow ink nozzle be more easily recognized visually, it may be configured that the yellow ink and the cyan ink are configured to land on the background image BG that is formed with white ink in an overlapping manner, and the mixed nozzle test pattern NP(CY) is formed as the nozzle test pattern NP of the yellow ink nozzle (in other words, the third process may be configured to be performed after the fourth process).

In addition, in the above-described embodiment, the printer driver 111 generates the print data for the nozzle test pattern NP, the controller 60 of the printer 10 receives the print data from the printer driver 111, and the nozzle test pattern NP is formed based on the print data. Thereafter, the printer driver 111 generates the print data for each nozzle test pattern NP based on the type (in particular, the color of the test sheet TS that is designated by the user on the designation screen 124 or the color of the test sheet TS that is measured by the color measuring device 51) of the test sheet TS. However, the invention is not limited thereto. For example, the print data may be configured to be stored in the memory 63 of the printer 10. In other words, when the controller 60 of the printer 10 forms the nozzle test pattern NP, the print data stored in the memory 63 may be configured to be read out. Hereinafter, such a configuration will be described in detail.

In the above-described configuration, in the memory 63 of the printer 10, print data for each nozzle test pattern NP is stored in association with the color of the test sheet TS. The correspondence relationship between the print data and the test sheet TS is the same as the above-described correspondence relationship (see FIG. 16).

When a user clicks on the nozzle testing button 122a, the printer driver 111 outputs a command for forming the nozzle test pattern NP to the printer 10, and the controller 60 of the printer 10 receives the command. Thereafter, the controller 60 determines the color of the test sheet TS that is prepared for forming the nozzle test pattern NP. In addition, the controller 60 may be configured to determine the color of the test sheet TS based on the information (for example, information representing the color designated by the user on the designation screen 124) transmitted from the printer driver 111. Alternatively, the controller 60 may be configured to determine the color of the test sheet TS by measuring the color of the test sheet TS by using the color measuring device 51 so as to determine the color.

Then, the controller 60 reads out print data of the nozzle test patterns NP, which is stored in the memory 63, corresponding to the determined color and forms the nozzle test patterns NP based on the read-out print data. Here, the print data stored in the memory 63 is classified into the above-described three types. The controller 60 forms the nozzle test pattern NP based on the print data corresponding to the color of the determined test sheet TS. In other words, the controller 60 determines whether to perform the first process or the second process for forming the nozzle test pattern NP in accordance with the determined color. Then, the controller 60 determines whether to perform the third process or the fourth process for forming the nozzle test pattern NP, which is formed by the first process, of the above-described nozzle test patterns NP in accordance with the color of the test sheet TS and the color of ink ejected from the test target nozzle.

As described above, it may be configured that the print data for each nozzle test pattern NP is stored in the memory 63 of the printer 10 in association with the color of the test sheet TS, the controller 60 of the printer 10 determines the color of the test sheet TS, and the print data corresponding to the determined color is read out from the memory 63. Even in such a configuration, the controller 60 performs either the first process or the second process as the process for forming the nozzle test pattern NP in accordance with the color of the test sheet TS.

In addition, in the above-described embodiments, the color of the test sheet TS is determined based on the type of the test sheet TS. Then, the controller 60 performs either the first process or the second process as the process for forming the nozzle test pattern NP in accordance with the color of the test sheet TS. However, the invention is not limited thereto. Thus, as the type of the test sheet TS, for example, the category (for example, a plain sheet, a color sheet, a transparent film, or the like) of the test sheet TS may be determined. The colors of media S that are assumed to be used in the printer 10 are already known. Accordingly, for example, in the designation screen 124 shown in FIG. 15, instead of the color of the test sheet TS, the category of the test sheet TS may be configured to be selected. In other words, as information on the type of the test sheet TS on which the nozzle test pattern NP is formed, information that can be selected for allowing the nozzle test pattern NP to be more easily recognized visually in relation to the color of the medium S may be used.

In addition, in the above-described embodiment, the printer 10 (a so-called serial printer) that has the head 23 moving in the moving direction has been described. However, the invention is not limited thereto. For example, an embodiment of the invention may be applied to a printer (a so-called line printer) that has a head 23 disposed in a fixed position without moving and can form once a plurality of dots aligned along the direction intersecting the transport direction of the medium S.

In addition, in the above-described embodiment, as an example of the liquid ejecting apparatus, the printer 10 that forms an image by ejecting ink has been described. However, an embodiment of the invention may be applied to a liquid ejecting apparatus that ejects liquids (including a liquid body in which particles of function materials are dispersed and a liquid body such as gel other than the liquid) other than ink.

As examples of such liquid injecting apparatuses, there are: a liquid ejecting apparatus that ejects a liquid that contains a material such as an electrode material or a coloring material in a dispersed form or dissolved form that is used for manufacturing a liquid crystal display, an EL (electroluminescence) display, or a field emission display or the like; a liquid ejecting apparatus that ejects bioorganic material that is used for manufacturing a bio chip; and a liquid ejecting apparatus that is used as a precision pipette and ejects a liquid that becomes a test material. In addition, the invention may be applied to: a liquid ejecting apparatus that ejects a lubricant to a precision machine such as a clock or a camera in a pin-point manner; a liquid ejecting apparatus that ejects a transparent resin liquid such as an ultraviolet-curable resin onto a substrate for forming a tiny hemispherical lens (optical lens) used in an optical communication element or the like; a liquid ejecting apparatus that ejects an acid etching solution, alkali etching solution, or the like for etching a substrate or the like; or a liquid-body ejecting apparatus that ejects a gel.

What is claimed is:

1. A liquid ejecting apparatus comprising:
a head that includes a plurality of nozzles disposed for each color of liquids and ejects liquids from the plurality of nozzles onto a medium; and
a control unit that forms a nozzle test pattern for testing defective liquid-ejection of a test target nozzle with one from the plurality of nozzles set as the test target nozzle,
wherein the control unit performs either a first process in which the nozzle test pattern is formed by having liquids ejected from the test target nozzle and a different nozzle, which is different from the test target nozzle, from the plurality of nozzles, land on the medium in an overlapping manner, or a second process in which the nozzle test pattern is formed by having only the liquid ejected from the test target nozzle land on the medium in accordance with the type of the medium.

2. The liquid ejecting apparatus according to claim 1, wherein the control unit forms the nozzle test patterns with each of the plurality of nozzles set as the test target nozzle and determines whether to perform the first process out of the first process and the second process for forming the nozzle test pattern of the nozzle test patterns in accordance with the type of the medium.

3. The liquid ejecting apparatus according to claim 2,
wherein the control unit performs either a third process in which the nozzle test pattern, which has a color that is different from the color of the liquid ejected from the test target nozzle, is formed by having the liquids ejected from the test target nozzle and the different nozzle land on the medium in an overlapping manner so as to be mixed together, or a fourth process in which the nozzle test pattern, that is surround by a base and is formed with the liquid ejected from the test target nozzle, is formed by forming the base that is formed with the liquid ejected from the different nozzle by having the liquid ejected from the different nozzle land on the medium and then having the liquid ejected from the test target nozzle land on the base, as the first process; and
wherein the control unit determines whether to perform either the third process or the fourth process for forming the nozzle test pattern of the nozzle test patterns, which is formed by the first process, in accordance with the type of the medium and the color of the liquid ejected from the test target nozzle.

4. The liquid ejecting apparatus according to claim 3, wherein, when both the color of the medium as the type of the medium and the color of the liquid ejected from the test target nozzle are a chromatic color of the same color, the control unit forms the nozzle test pattern for testing defective liquid-ejection of the test target nozzle by the third process.

5. The liquid ejecting apparatus according to claim 3, wherein, when both the color of the medium as the type of the medium and the color of the liquid ejected from the test target nozzle are white, the control unit forms the nozzle test pattern for testing defective liquid-ejection of the test target nozzle by the fourth process.

6. The liquid ejecting apparatus according to claim 3, wherein, when the medium is a transparent medium and the color of the liquid ejected from the test target nozzle is a chromatic color, the control unit forms the nozzle test pattern for testing defective liquid-ejection of the test target nozzle by the fourth process.

7. The liquid ejecting apparatus according to claim 1, further comprising a color measuring device for measuring the color of the medium,
wherein the type of the medium is defined as the color that is measured by the color measuring device.

8. A method of forming a nozzle test pattern in which the nozzle test pattern for testing defective liquid-ejection of a test target nozzle is formed on a medium with one from a plurality of nozzles disposed for each color of liquids set as the test target nozzle, the method comprising:
determining the type of the medium; and
performing either a first process in which the nozzle test pattern is formed by having liquids ejected from the test target nozzle and a different nozzle, which is different from the test target nozzle, from the plurality of nozzles, land on the medium in an overlapping manner, or a second process in which the nozzle test pattern is formed by having only the liquid ejected from the test target nozzle land on the medium in accordance with the determined color of the medium.
